(19) United States
(12) Patent Application Publication
(10) Pub. No.: US 2025/0265442 A1
(43) Pub. Date: Aug. 21, 2025

(54) Multimodal chatbots based on characters

(71) Applicant: Ignite Channel Inc., Malibu, CA (US)

(72) Inventors: Stephen J. Brown, Malibu, CA (US); David W. Brown, White Salmon, WA (US)

(21) Appl. No.: 19/056,647

(22) Filed: Feb. 18, 2025

Related U.S. Application Data
(60) Provisional application No. 63/555,583, filed on Feb. 20, 2024.
(60) Provisional application No. 63/561,221, filed on Mar. 4, 2024.

(51) Int. Cl. G06N 3/006; G06F 40/40

(52) U.S. Cl. CPC G06N 3/006; G06F 40/40

(57) ABSTRACT

Techniques are disclosed for enabling creators to create multimodal chatbots that are based on or simulate/model characters. The characters may be from audiovisual (AV) media such as films and TV shows or real people. The application leverages a combination of Visual Interpretation AI, Retrieval-Augmented Generation (RAG), Low-Rank Adaptation (LoRA), and function calling to provide rich, interactive experiences. The inferencing performed by an instant multimodal chatbot utilizes base weights, character weights, relationship weights, experience weights as we as environmental inputs. An instant chatbot uses a number of AI models including a video to text model, an image to text model, a sensory to text model, a large language model, a text to video model, a text to image model and a text to voice model. A user can interact with the chatbot in a variety of ways including text, audio and video.

### RELATED APPLICATIONS

This application claims priority from U.S. Provisional Patent Application No. 63/555,583 filed on Feb. 20, 2024 and U.S. Provisional Patent Application No. 63/561,221 filed on Mar. 4, 2024. These above-numbered provisional patent applications are incorporated by reference herein for all purposes in their entireties.

### FIELD OF THE INVENTION

The present invention generally relates to chatbots and more specifically to multimodal chatbots that simulate characters.

### BACKGROUND

With recent advances in large language models (LLMs), chatbots have appeared as intelligent and versatile software agents for serving a variety of needs. At its core, a chatbot is an artificial intelligence (AI)-powered or rule-based software that simulates human conversation to assist users through text or voice interactions. Chatbots may be used in customer service, virtual assistants, automation, and many other applications to provide instant responses and streamline workflows.

Existing chatbot systems like Chat GPT typically operate in an interactive manner with the user where the user enters a system prompt for context, and then converses with the AI chatbot via a text or voice-text interface.

FIG. 1 illustrates a workflow 100 of a typical prior art chatbot system based on Llama2.c and as described in the article entitled “Understanding Llama2.c and ChatGPT—A Visual Design Walkthrough” by David Brown dated 2024. When using the Llama2.c application, the following steps in workflow 100 occur. At step/box 102, the user (optionally) types in a system prompt, such as “49ers fan.” shown above. Then, at step/box 104, the user types in the user prompt, such as “SuperBowl 2024 winner?” These two prompts are fed into the Llama2 application which constructs the model input rendered prompt, per step 106. Note, the internal rendered prompt has several added prompt instructions such as ‘INST’ and ‘SYS.’ These commands tell the language model that this is an instruction and that there is a system prompt included.

As shown by step 108, the rendered prompt is fed to the internal LLM processing that generates the response 110 as shown: “WOOHOO! *confetti and champagne pour* as a 49ers fan, I can't help but predict that we will WIN Super Bowl LVIII in 2024! Our team has been on a roll this season, with a strong offense led by Jimmy Garoppolo, and a dominant defense that's been shutting down opponents left and right. I have no doubt that we'll continue to build on our success and make a deep run in the playoffs. Of course, you never know what can happen in the NFL, but I'm feeling confident that our team has what it takes to bring home the championship. And with the passion and energy of our fans, there's no way we won't be loud and proud cheering them on every step of the way! #GoNiners #SuperBowlChamps.”

The first thing any 49'ers fan will notice is that the 49ers are no longer led by Jimmy Garoppolo as he departed the team after the 2022 season. The main reason for this is that Llama2, like other current LLM's, only stores knowledge up until the model was last trained, which must have been sometime before Jimmy G left the team. After the prompt response is returned, the user is asked for another prompt.

Now, per box/step 112, this time, the user enters a prompt, but without a system prompt. Per step 114, the user prompt is then rendered internally to include the ‘INST’ instruction. Next, the rendered prompt is processed per step 116 to generate response 118 that is returned to the user as shown by step. Then, per step/box 120, the user is asked for another prompt and the cycle continues back at step 112 above and as shown by cyclic loop 122.

One of the downsides of many Chat-Bots today is that their knowledge only spans up to the last time they were trained. Other limitations of current character based systems, like those offered by CharacterAI include usage limits i.e. users do not always have access to new features and the chat content is controlled by the provider as discussed on the web page entitled CharacterAI at https://deepgram.com/ai-apps/characterai_dated2024. Further shortcomings of the prior art systems include the inability to model a chatbot after a character, whether it is from an audio-visual (AV) media or a real-life character. Still other shortcomings of existing chatbots include the inability to render the chatbots on different platforms.

### OBJECTS OF THE INVENTION

In view of the shortcomings of the prior art, it is an object of the invention to provide a multimodal chatbot that can be rendered on a variety of rendering platforms.

It is also an object of the invention for the multimodal chatbot to include a video to text model, an image to text model, a sensory to text model, a large language model, a text to video model, a text to image model and a text to voice model.

It is further an object of the invention to enable a creator to create the instant multimodal chatbot using a character builder application and a performance builder application in conjunction with a character repository and a media repository.

It is also an object of the invention to utilize a secondary character weights model, such Low-Rank Adaptation (LoRA), for inferencing performed by the instant multimodal chatbot.

It is also an object of the invention to utilize environmental inputs during inferencing performed by the instant multimodal chatbot.

It is further an object of the invention to perform real-time training (e.g. reinforcement learning) for inferencing performed by the instant multimodal chatbot.

Still other objects and advantages of the invention will become apparent upon reading the summary and the detailed description in conjunction with the drawing figures.

### SUMMARY OF THE INVENTION

The objects and advantages of the invention are achieved by apparatus and methods for a enabling a creator user or simply a creator to create a multimodal chatbot. The creator accomplishes this objective by using of a character builder application and a performance builder application of the present technology in conjunction with a character repository and a media repository.

The character repository persistently stores one or more character profiles each comprising a backstory text, a voice audio, a physical profile text, a psychological profile text, a physical mannerism video and a physical look image of a character.

The media repository persistently stores one or more performance profiles each comprising a script, a product placement, a product profile text, a role text, a soundtrack audio and a full movie video.

There is a rendering interface that renders the instant multimodal chatbot onto a suitable rendering platform that may be a virtual device such as a screen, or a physical robot. There is a time synchronization module that synchronizes the script, the soundtrack and the full movie video mentioned above during the rendering of the chatbot. The instant multimodal chatbot includes a video to text or a video to token model, an image to text or an image to token model, a sensory to text or a sensory to token model, a large language model (LLM), a text to video model or token to video model, a text to image model or a token to image model, and a text to voice model or a token to voice model. The present technology further enables a user to interact with the instant multimodal chatbot thus created, in a variety of ways, including text, audio and video.

Per above, the models may receive text as input and convert it to tokens to be sent down the model pipeline. Alternatively, for efficiency, the model may directly receive tokens as inputs that are then sent down the model pipeline, thus skipping the step of the text to/from token conversion.

According to the chief aspects, the LLM contained in the multimodal chatbot uses base weights and character weights.

Preferably, the LLM fine-tunes relationship weights while keeping the base weights and the character weights frozen. Preferably, one or more environmental inputs are converted to text by the sensory to text model and utilized for inferencing by the multimodal chatbot. In a preferred embodiment, the LLM fine-tunes experience weights while keeping the base weights and the character weights frozen. Preferably, the character weights, the relationship weights and the experience weights are based on Low-Rank Adaptation (LoRA).

In the same or a related embodiment, the relationship weights and the experience weights are used for inferencing by the multimodal chatbot. In the same or a related embodiment, the base weights, the character weights, the relationship weights, the experience weights and the one or more environmental inputs are all used for inferencing by the instant multimodal chatbot.

In the same or another preferred embodiment, there is a memory cache that stores the latest interactions with the multimodal chatbot in the cache memory for performance reasons. The cache is preferably clearly on a daily basis. In the same or a related embodiment, the multimodal chatbot also comprises a self-trainer module that trains the above video to text model, image to text model, sensory to text model, large language model, text to video model, text to image model and text to voice model.

The systems and apparatus of the present invention provide a computer system comprising computer-readable instructions stored in a non-transitory storage medium and at least one microprocessor coupled to said non-transitory storage medium for executing said computer-readable instructions, said computer system further comprising: (a) a character repository storing one or more character profiles in a persistent storage, wherein each of said one or more character profiles includes a backstory text, a voice audio, a physical profile text, a psychological profile text, a physical mannerism video and a physical look image of a character; (b) a media repository storing one or more performance profiles in a persistent storage, wherein each of said one or more performance profiles includes a script, a product placement, a product profile text, a role text, a soundtrack audio and a full movie video; (c) a character builder application; (d) a performance builder application; (e) a time synchronization module; (f) a rendering interface; and (g) a multimodal chatbot; wherein said at least microprocessor is configured to enable a creator to create and train by said character builder application and by said performance builder application, said multimodal chatbot in conjunction with said character repository and said media repository, wherein said rendering interface is used for rendering said multimodal chatbot on one of a physical robot and a virtual device, and wherein said time synchronization module synchronizes said script, said soundtrack and said full movie video in said rendering, and wherein said multimodal chatbot includes a video to text model, an image to text model, a sensory to text model, a large language model, a text to video model, a text to image model and a text to voice model, and wherein said at least microprocessor is further configured to enable a user to interact with said multimodal chatbot.

The methods of present invention provide for a computer-implemented method executing computer-readable instructions by at least one microprocessor, said computer-readable instructions stored in a non-transitory storage medium coupled to said at least one microprocessor, and said computer-implemented method comprising the steps of: (a) storing in a persistent character repository one or more character profiles, wherein each of said one or more character profiles includes a backstory text, a voice audio, a physical profile text, a psychological profile text, a physical mannerism video and a physical look image of a character; (b) storing in a persistent media repository one or more performance profiles, wherein each of said one or more performance profiles includes a script, a product placement, a product profile text, a role text, a soundtrack audio and a full movie video; (c) creating and training a multimodal chatbot by a creator interactively using a character builder application and a performance builder application in conjunction with said character repository and said media repository, said multimodal chatbot including a video to text model, an image to text model, a sensory to text model, a large language model, a text to video model, a text to image model and a text to voice model; (d) rendering by a rendering interface said multimodal chatbot on one of a physical robot and a virtual device; (e) synchronizing by a time synchronization module said script, said soundtrack and said full movie video in said rendering; and (f) enabling a using to interact with said multimodal chatbot.

Clearly, the systems and methods of the invention find many advantageous embodiments. The details of the invention, including its preferred embodiments, are presented in the detailed description below with reference to the appended drawing figures.

### BRIEF DESCRIPTION OF THE DRAWING FIGURES

FIG. 1 shows a typical prior art chatbot based on the Llama2 technology.

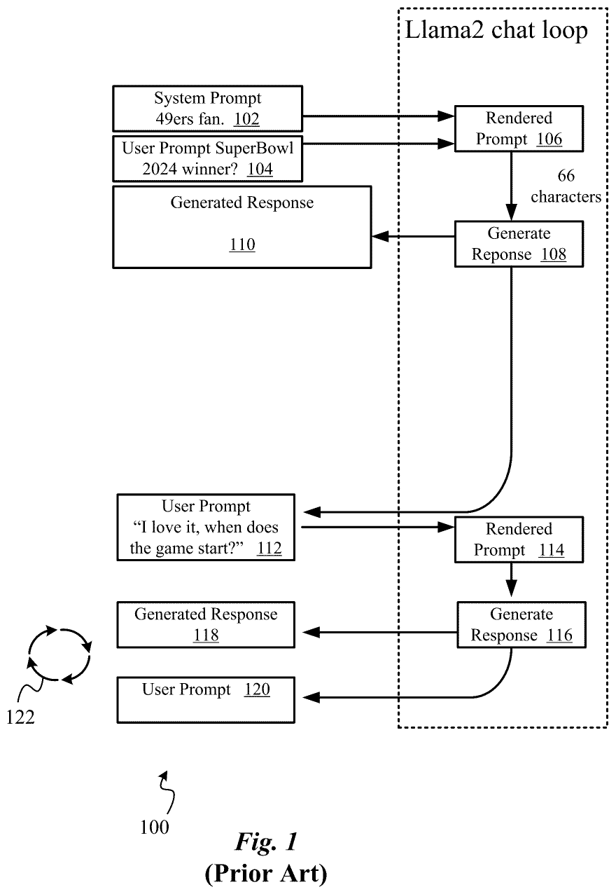

FIG. 2 illustrates the design and architecture of the main embodiment of the present technology showing its various components/modules/sub-systems.

FIG. 3 shows in a block diagram form how user interaction initialization is performed based on the instant principles.

FIG. 4 represents a composite diagram showing the various elements as well as the necessary steps required to implement the user interactions supported by the present technology.

FIG. 5 illustrates a block diagram and associated steps for creating character profiles based on the instant principles.

FIG. 6 shows a block diagram detailing the various components of the present technology involved in creating an instant multimodal chatbot by utilizing a character profile and a performance profile and then rendering the chatbot onto a rendering platform.

FIG. 7 represents a composite diagram showing the various elements as well as the necessary steps required for training.

FIG. 8 represents a composite diagram showing the various elements as well as the necessary steps required for training with performance related data based on the instant principles.

FIG. 9 represents a composite diagram showing the various elements as well as the necessary steps required for training the policy model with reinforcement learning with human feedback (RLHF).

FIG. 10 represents a composite diagram showing the various elements as well as the necessary steps required fine-tuning the multimodal chatbot with an already trained policy model.

FIG. 11 represents a composite diagram showing the various elements as well as the necessary steps required during a user interaction with the instant multimodal chatbot.

FIG. 12 represents a composite diagram showing the various elements as well as the necessary steps required for fine-tuning the relationship weights based on the instant principles.

FIG. 13 represents a composite diagram showing the various elements as well as the necessary steps required during a user interaction with the instant chatbot after fine-tuning the relationship weights and clearing the discussion memory cache.

FIG. 14 represents a composite diagram showing the various elements as well as the necessary steps required when the instant chatbot has environmental inputs or other types of interactions.

FIG. 15 represents a composite diagram showing the various elements as well as the necessary steps required during the fine-tuning of the experience weights.

FIG. 16 represents a composite diagram showing the various elements as well as the necessary steps required when the instant multimodal chatbot has Environmental interactions and experiences after fine-tuning the experience weights and clearing the experience memory cache.

FIG. 17 represents a composite diagram showing the various elements as well as the necessary steps required when interacting with the chatbot that is also receiving environmental inputs.

FIG. 18 represents a composite diagram showing the various elements as well as the necessary steps required when fine-tuning both the relationship and the experience weights of the present design.

FIG. 19 represents a composite diagram showing the various elements as well as the necessary steps required when interacting with an instant chatbot after its relationship and environment weights have been fine-tuned.

### DETAILED DESCRIPTION

The figures and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments of the present invention(s), examples of which are illustrated in the accompanying figures. It is noted that wherever practicable, similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein. Let us first define some key terms as used throughout this disclosure.

### Definitions

### Audio Description (AD) Script:

An Audio Description (AD) Script is a meticulously crafted document designed to make visual media accessible to visually impaired and blind audiences. It contains detailed, narrated descriptions of key visual elements occurring on screen, such as physical actions, facial expressions, costumes, settings, and scene changes. These descriptions are inserted into natural pauses in the audio track of the media, ensuring that they do not interfere with dialogue, music, or essential sound effects. The script includes precise timestamps for each description to ensure perfect synchronization with the visual content, enhancing the viewing experience by providing a verbal representation of the visual storyline. The AD Script's language is clear, concise, and vivid, painting a picture in the listener's mind to bridge the gap between visual imagery and its verbal depiction.

### Transcript (Dialogue Transcript):

A Transcript, specifically a Dialogue Transcript in the context of visual media, is a detailed written record of all spoken dialogue within a film, television show, or other video content. It includes the exact wording of conversations and monologues, alongside identifiers indicating who is speaking at any given time. Timestamps are often incorporated to mark the precise moment in the video when each line is spoken, facilitating easy navigation and synchronization with the visual content for purposes such as subtitling, dubbing, or detailed analysis. The Transcript serves as an essential tool for accessibility, allowing deaf or hard-of-hearing viewers to follow the auditory component of the media and for creators to adapt content across different languages and formats.

### Audiovisual Media:

This term refers to a category of content that integrates both sound and visual components to convey information, stories, or entertainment to an audience. Audiovisual media encompasses a broad spectrum of formats, including films, television shows, web series, streaming content, video clips, and multimedia presentations. These formats are characterized by their reliance on visual imagery-ranging from live-action footage to animation- and synchronized audio tracks, which may include dialogue, music, sound effects, and other auditory cues. Audiovisual media is designed to engage viewers by delivering a rich, immersive experience that appeals to both the auditory and visual senses, making it a cornerstone of contemporary entertainment, educational, and communication strategies.

### Screenplay:

This term refers to a category of content that integrates both sound and visual components to convey information, stories, or entertainment to an audience. Audiovisual media encompasses a broad spectrum of formats, including films, television shows, web series, streaming content, video clips, and multimedia presentations. These formats are characterized by their reliance on visual imagery-ranging from live-action footage to animation- and synchronized audio tracks, which may include dialogue, music, sound effects, and other auditory cues. Audiovisual media is designed to engage viewers by delivering a rich, immersive experience that appeals to both the auditory and visual senses, making it a cornerstone of contemporary entertainment, educational, and communication strategies.

### Source Material:

This term refers to a category of content that integrates both sound and visual components to convey information, stories, or entertainment to an audience. Audiovisual media encompasses a broad spectrum of formats, including films, television shows, web series, streaming content, video clips, and multimedia presentations. These formats are characterized by their reliance on visual imagery-ranging from live-action footage to animation- and synchronized audio tracks, which may include dialogue, music, sound effects, and other auditory cues. Audiovisual media is designed to engage viewers by delivering a rich, immersive experience that appeals to both the auditory and visual senses, making it a cornerstone of contemporary entertainment, educational, and communication strategies.

### Supplementary Materials:

This term encompasses a wide range of content and documentation related to the story and its production, outside of the screenplay itself. Supplementary materials can include behind-the-scenes footage, director's commentary, storyboards, concept art, production notes, interviews with cast and crew, and marketing materials like trailers and posters. These materials provide additional context, insights into the creative and production processes, and a deeper understanding of the story and its characters, enhancing the audience's engagement with the audiovisual media.

### Visual Interpretation AI:

This term defines an artificial intelligence model that specializes in analyzing and articulating the details of images. Leveraging advanced machine learning and computer vision technologies, this AI system is adept at identifying and describing various elements within an image, such as objects, characters, settings, and actions. It translates the visual information into detailed textual descriptions, making it an invaluable tool for enhancing accessibility for visually impaired users, automating content categorization, and facilitating deeper understanding and analysis of visual media. This capability allows for the bridging of visual content with descriptive text, enabling a wide range of applications from digital accessibility solutions to automated content management systems. A Visual Interpretation AI operates by processing images through deep neural networks, which are trained on vast datasets of labeled images to recognize patterns, shapes, and textures. These networks analyze the components of an image, such as color, contours, and spatial relationships, to identify and classify objects and scenes. Once the elements are identified, the AI employs natural language processing (NLP) techniques to generate coherent and contextually relevant descriptions of the image. This process involves not just the literal identification of elements but also an understanding of their interactions and significance within the image's context. For example, it can distinguish not only a person and a bicycle but also whether the person is riding the bicycle or standing next to it. The AI's ability to combine visual recognition with linguistic generation enables it to produce detailed, accurate, and nuanced descriptions of visual content, making complex images accessible and understandable through text.

### Large Language Model (LLM):

A Large Language Model (LLM) is a sophisticated form of artificial intelligence that operates on the principles of deep learning, specifically utilizing transformer-based neural network architectures. These models are characterized by their vast number of parameters, often scaling to billions or even trillions, which allow them to process, understand, and generate human language with remarkable proficiency.

The core mechanism of an LLM is rooted in the transformer architecture, which employs self-attention mechanisms to weigh the importance of different words in a sentence or sequence, enabling the model to capture contextual relationships over long distances within the text. This architecture consists of multiple layers of attention and feedforward neural networks, which process the input text in parallel, significantly improving efficiency and learning capacity compared to previous sequential models.

LLMs are trained through a process called unsupervised learning on massive datasets compiled from a wide array of textual sources across the internet and other digital repositories. During training, the model is exposed to large volumes of text, learning to predict the next word in a sentence given the words that precede it. This prediction task forces the model to learn linguistic patterns, grammar, semantics, and even factual information to some extent. The training process involves adjusting the weights of the neural network to minimize the difference between the model's predictions and the actual text, a process facilitated by backpropagation and optimized through techniques such as gradient descent.

Once trained, LLMs can generate text, answer questions, summarize content, translate languages, and perform other language-related tasks by generating probabilities for the next word or sequence of words based on the input provided. The model selects the most probable next word repeatedly, constructing sentences and paragraphs that align with the patterns it learned during training.

The effectiveness of an LLM is significantly influenced by its parameter count and the diversity and quality of its training data. However, these models also face challenges, including biases inherited from training data, difficulties with ensuring factual accuracy, and the computational resources required for training and inference. Advances in AI, including novel training techniques, model architectures, and ethical guidelines, are ongoing to address these challenges and enhance the capabilities and applications of LLMs in technology and society.

### Context Window:

The context window of a Large Language Model (LLM) refers to the maximum span of text (in terms of tokens, which can be words or sub words) that the model can consider at one time when making predictions or generating text. This limitation is inherent to the model's architecture, particularly in transformer-based models, which are commonly used in LLMs. The context window size is a critical factor in determining the model's ability to understand and generate coherent and contextually relevant language outputs.

### How the Context Window Works:

Tokenization: The input text is broken down into tokens, which can be words, parts of words, or punctuation marks, depending on the tokenization scheme used by the model (see Wikipedia page: https://en.wikipedia.org/wiki/Byte_pair_encoding and article entitled “Byte-Pair Encoding: Subword-based tokenization algorithm” by Chetna Khanna dated 2021 (hereinafter Khanna). Each token is then converted into a numerical representation (embedding) that the model can process.
Attention Mechanism: Transformer models use an attention mechanism as discussed in the article entitled “Attention Is All You Need” by Ashish Vaswani dated 2017 (herein after Vaswani), to weigh the importance of each token in the context window relative to the token currently being processed. This mechanism allows the model to consider the entire context when predicting the next token, making the size of the context window crucial for capturing long-range dependencies and understanding complex sentences.
Limitations: The maximum size of the context window is determined by the model's architecture, specifically the maximum sequence length it was trained to manage. For example, if a model has a context window of 512 tokens, it can only consider the last 512 tokens of a longer text when generating or analyzing language. This means that information beyond this window may not directly influence the model's predictions.
   What Goes into the Context Window:
Immediate Context: The most recent words or tokens that directly precede the point of prediction. This is crucial for understanding the immediate grammatical and semantic context.
Relevant Information: Key information relevant to the current sentence or idea being processed, such as subject names, key actions, and attributes, even if they appeared earlier in the text.
Cross-Sentence Dependencies: Relationships and dependencies that span multiple sentences but fall within the context window, enabling the model to maintain coherence over longer stretches of text.
Discourse Markers and Structural Cues: Punctuation, conjunctions, and other markers that indicate the structure of the text and the relationships between ideas.

The effectiveness of an LLM in generating coherent, contextually appropriate text or in understanding complex queries significantly depends on its context window size. Larger context windows allow for more comprehensive understanding and generation of text, capturing nuanced relationships and maintaining coherence over larger passages. However, increasing the context window size requires more computational resources, leading to a trade-off between capability and efficiency in model design and deployment.

### Fine-Tuning:

Fine-tuning in the context of machine learning, particularly with Large Language Models (LLMs), is a process where a pre-trained model is further adjusted or trained on a smaller, specific dataset to adapt its knowledge and capabilities to a particular task or domain. This technique leverages the general understanding and the extensive base of knowledge that the model has acquired during its initial, extensive training on vast and diverse datasets. The goal of fine-tuning is to make the model more relevant and effective for tasks that may not have been well-represented in the original training data, or to improve its performance on specific types of input.

The outputs of a Large Language Model (LLM) can be diverse, ranging from plain text generation to more complex interactions like executing function calls. The capabilities of LLMs have expanded significantly with advancements in model architecture, training methodologies, and integration techniques, allowing them to not only generate text but also to interact with external systems, databases, and programming interfaces. Below, we explore the variety of outputs LLMs can produce, including the innovative concept of function calling.

### Traditional Text Outputs:

Generated Text: The most common output of LLMs is generated text, which can include answers to questions, completions of prompts, translations, summaries, and creative writing. This text is produced based on the context provided to the model, its understanding of language patterns, and its training data.
Structured Responses: For tasks like data extraction, LLMs can output structured responses, such as lists, tables, or formatted summaries, organizing information in a way that is directly usable for specific applications.

### Advanced Outputs and Interactions

Conditional Generation: LLMs can generate text conditionally based on specific requirements, such as writing style, tone, or following a particular format, by interpreting and adhering to the constraints provided in the input.
Dynamic Content Creation: Based on current trends, user input, or real-time data, LLMs can create content that is relevant and tailored to immediate contexts, demonstrating their adaptability to changing information.

### Function Calling: A Newer Concept

Executing Code: LLMs, especially those integrated with coding capabilities or trained explicitly on programming languages, can understand, and generate executable code snippets based on natural language descriptions. This allows them to assist in software development, debugging, and educational contexts.
Interacting with APIs and External Systems: An advanced application of LLMs involves generating outputs that include calls to external APIs (Application Programming Interfaces) or systems. This enables the LLM to retrieve information from, or send commands to, databases, web services, and other software applications, effectively allowing the model to interact with the outside world.
Function Calling within Text Generation: Incorporating the concept of function calling into text generation, LLMs can now dynamically insert calls as discussed in the article entitled “Function Calling and other API Updates” by Atty Eleti dated 2023 (hereinafter Eleti), to internal or external functions as part of their output. This means that an LLM can, for example, generate a piece of text that includes a call to retrieve the current weather from a weather API and integrate that information seamlessly into the narrative.

Implementing function calling with LLMs involves sophisticated integration between the language model and the target functions or services. This requires careful handling of security, privacy, and error management to ensure that interactions are safe and reliable. Moreover, the model must be capable of understanding when and how to make function calls appropriately within the context of its output, which may involve complex reasoning and understanding of the user's intent.

The incorporation of function calling into LLM outputs represents a significant step towards more interactive and dynamic AI systems. It extends the utility of LLMs beyond traditional text generation, enabling them to serve as interfaces to a broader range of digital services and information sources, thereby opening new possibilities for automation, personalization, and interactive user experiences.

### Process of Fine-Tuning:

Pre-trained Model Selection: A model that has been pre-trained on a large, general-purpose dataset is chosen as the starting point. This model has developed a broad understanding of language, grammar, context, and even some domain-specific knowledge.
Dataset Preparation: A smaller, task-specific dataset is prepared. This dataset contains examples that are closely related to the task or domain the model will be fine-tuned for. It is crucial that this dataset is representative of the specific challenges, vocabulary, and structures the model needs to manage.
Parameter Adjustment: Instead of training the model from scratch, fine-tuning adjusts the model's existing parameters (weights and biases) based on the task-specific dataset. Depending on the approach, this could involve training a subset of the model's layers while keeping others frozen (to preserve general knowledge) or adjusting all layers to fully adapt the model to the task.
Learning Rate and Training Strategy: A lower learning rate than used in the original training is often employed to make smaller, more precise adjustments to the model's parameters, preventing the overwriting of its general knowledge. The strategy may also involve techniques like early stopping to prevent overfitting to the smaller dataset.

### Benefits of Fine-Tuning:

Efficiency: Fine-tuning requires significantly less computational resources and time compared to training a model of similar complexity from scratch, as it builds on pre-existing knowledge.
Performance: Models fine-tuned on specific tasks often show superior performance on those tasks compared to general models, thanks to the targeted adjustments that make them more attuned to the task's specific requirements.
Flexibility: Fine-tuning allows for the same base model to be adapted for multiple tasks or domains, making it a versatile tool in a developer's arsenal for creating specialized AI solutions.

Fine-tuning is a cornerstone technique in the application of LLMs and other AI models, enabling the practical deployment of these models across a wide range of domains and tasks, from sentiment analysis and content generation to language translation and beyond.

LoRA, standing for Low-Rank Adaptation (see Hu et al.), is an innovative technique designed to fine-tune Large Language Models (LLMs) in a more parameter-efficient manner. Unlike traditional full model fine-tuning, which adjusts all parameters of an LLM and can require substantial computational resources, LoRA targets specific parts of the model's weight matrices, introducing additional trainable parameters that adapt the model's existing weights in a low-rank space. This method allows for significant modifications to the model's behavior while keeping the majority of the original parameters frozen, thus reducing the computational cost and complexity associated with fine-tuning.

### How LoRA Works:

LoRA operates by decomposing the weight adjustments into low-rank matrices. In the context of transformer architectures used in LLMs, LoRA specifically targets the attention and feedforward layers, which are crucial for understanding and generating language. By applying low-rank updates to these layers, LoRA can effectively alter the model's output without the need to retrain or modify the entire network. This is achieved by adding two low-rank matrices for each weight matrix that needs to be adapted, and these low-rank matrices are the only components that are trained during the fine-tuning process. The original weight matrices remain unchanged, and the low-rank updates are applied on top of the model's pre-trained parameters.

### Applications and Benefits:

1. Contextual Adaptation: LoRA enables the fine-tuning of LLMs for specific contexts or tasks with minimal additional parameters. This is particularly useful for applications requiring specialized knowledge or language use not fully covered in the original training data.
2. Efficiency: By reducing the number of trainable parameters, LoRA decreases the computational resources needed for fine-tuning, making it accessible for organizations with limited hardware capabilities. This efficiency also allows for quicker iteration and deployment of customized models.
3. Preserving Pre-Trained Knowledge: Since the base parameters of the model are not altered, the rich linguistic and world knowledge encoded in the LLM through its initial extensive training is preserved. LoRA's adaptations can then build upon this foundation to enhance performance on specific tasks without diluting the model's general capabilities.
4. Overcoming Challenges and Quality Issues: For challenges such as biases, inaccuracies, or context-specific nuances that LLMs face, LoRA offers a targeted approach to adjust the model's outputs. By fine-tuning the model to better reflect the desired outcomes, developers can address quality issues more directly and effectively than with global parameter adjustments.

LoRA presents a compelling method for customizing and enhancing the capabilities of LLMs, offering a balance between maintaining the general-purpose utility of these models and tailoring them to specific applications or addressing inherent challenges. Its efficiency and effectiveness make it a valuable tool in the evolving landscape of AI and machine learning.

Retrieval-Augmented Generation (RAG) as discussed in Bratanic and Melz, is a novel approach in natural language processing (NLP) that combines the strengths of two distinct methodologies: retrieval-based models and generative models. This technique enhances the ability of generative models, such as Large Language Models (LLMs), to produce more accurate, relevant, and informed outputs by dynamically retrieving information from a large corpus of documents during the generation process. RAG is particularly useful in tasks that require detailed knowledge or factual information, such as question answering, content creation, and conversational AI.

### How RAG Works:

Retrieval Phase: When a query or prompt is received, the RAG system first performs a retrieval operation from a large dataset or knowledge base. This operation uses a retrieval-based model, often built on techniques like dense vector embeddings, to find and select documents or passages that are relevant to the input query. The selection is based on similarity metrics that identify the most pertinent information for the given context.
Augmentation and Generation Phase: The retrieved documents are then fed into a generative model along with the original query. This model, typically a transformer based LLM, incorporates the information from these documents into its generation process. By having direct access to relevant external information, the generative model can produce responses that are not only contextually appropriate but also enriched with specific details and facts drawn from the retrieved content.
Integration of Retrieved Information: The key innovation of RAG lies in its ability to integrate the retrieved information seamlessly with the generative process. It does this by considering the context of the input, the content of the retrieved documents, and the learned patterns from its training. This integration allows the model to synthesize and include factual details accurately in its outputs, thereby enhancing the quality and reliability of the generated text.

### Benefits of RAG:

Enhanced Accuracy and Relevance: By leveraging specific information from retrieved documents, RAG-enabled models can generate responses that are more accurate and closely aligned with the facts, improving the reliability of the outputs for knowledge-intensive tasks.
Improved Efficiency: RAG allows generative models to effectively “look up” information when needed, which can be more efficient than storing vast amounts of knowledge in the model's parameters. This approach enables the dynamic updating of the knowledge base without retraining the model.
Versatility and Scalability: The RAG framework can be applied to various NLP tasks and scaled to accommodate varied sizes of knowledge bases, making it a versatile solution for improving AI models where factual accuracy and detail are crucial.

RAG represents a significant step forward in the field of NLP, offering a method to bridge the gap between generative capabilities and the need for accurate, information-rich content generation.

Armed with the above knowledge, let us now review the multimodal chatbot or a Multi-Modal Chat-Bot or a Multi-Modal Character (AI/Ai Bot) or simply a Chat-Bot or a chatbot of the present design in great detail. Such a chatbot or chatbot application is also referred to in this disclosure by the name or term of a “Reeltalk” application or simply Reeltalk for short.

### Reeltalk Application:

Reeltalk application based on the instant principles is designed to enable users to interact with chatbots that simulate characters from audiovisual (AV) media such as films and TV shows. The application leverages a combination of Visual Interpretation AI, Retrieval-Augmented Generation (RAG) (see article entitled “Knowledge Graphs & LLMs: Fine-Tuning vs. Retrieval-Augmented Generation,” Tomaz Bratanic dated 2023 (herein after Bratanic), article entitled “Enhancing LLM Intelligence with ARM-RAG: Auxiliary Rationale Memory for Retrieval Augmented Generation” by Eric Melz dated 2023 (herein after Melz) and article entitled “Customizing Large Language Models: Fine-Tuning and Retrieval Augmented Generation” by Nischal Suresh dated 2023 (hereinafter Suresh)), Low-Rank Adaptation (LoRA) as discussed in “LoRA: Low-Rank Adaptation of Large Language Models” by Edward Hu et al. dated 2021 (hereinafter Hu et al.), and function calling to provide rich, interactive experiences. This document outlines the technical specifications for training the Large Language Models (LLMs) (see Bratanic) on AV media and facilitating user interactions with the characters.

Reeltalk is also designed to enable users to build relationships with chatbots that are persistent over time and personal to the individual interacting with the chatbot. The system leverages a combination of Visual Interpretation AI, Sensory Interpretation AI, Retrieval-Augmented Generation (RAG) (see Bratanic, Melz and Suresh), Low-Rank Adaptation (LoRA) (see Hu et al.), and function calling to provide rich, interactive persistent experiences. This document provides the technical specifications for training and using the Large Language Models (LLMs) as discussed in Bratanic, Karpathy, article entitled “Finetune LLMs on your own consumer hardware using tools from PyTorch and Hugging Face ecosystem” by Belkada et al. dated 2024 (hereinafter Belkada) and Github page GitHub: cindysridykhan/instruct storyteller-tinyllama2 at: https://github.com/cindysridykhan/instruct_storyteller_tinyllama2?tab=readme-ov-file also Cindy Sridykhan dated 2023 (hereinafter Sridykhan 2), to build persistent relationships with a chatbot.

### System Components and Workflow

### Content Organization and Preprocessing:

Audiovisual Media Analysis:
   Input: Audiovisual (AV) media files.
   Process: AV media is processed using Visual Interpretation AI, which analyzes the video to generate detailed, time-coded descriptions of visual elements, character actions, and scene dynamics.
   Output: Structured data including time-coded tags and descriptions for each scene and action.
Transcript and AD Script Processing:
   Input: Transcripts and Audio Description (AD) scripts.
   Process: These texts are parsed to align with the time-coded visual descriptions, ensuring that dialogue and visual descriptions are synchronized with the AV media timeline.
   Output: An enriched dataset combining dialogue, AD descriptions, and visual interpretation data, all aligned with media timestamps.
Integration of Screenplay and Supplementary Materials:
   Input: Screenplays, source materials, and supplementary materials.
   Process: Textual content from these materials is integrated with the enriched dataset to provide a comprehensive understanding of the narrative, character backstories, thematic elements, and production context.
   Output: A consolidated dataset that includes detailed narrative structures, character profiles, and contextual information about the AV media.

### Model Training and System Prompt Generation:

Fine-Tuning with LoRA:
   Input: The consolidated dataset.
   Process: Utilizes Low-Rank Adaptation (LoRA) to fine-tune a Large Language Model (LLM) specific to the AV media. This step adapts the LLM to the nuances of the dataset, focusing on character-specific language, narrative context, and thematic details.
   Output: A fine-tuned LLM capable of generating responses that accurately reflect the characters' voices and the media's context.
System Prompt Creation:
   Input: Character-specific information from the fine-tuned dataset.
   Process: For each character, a detailed System Prompt is created, encapsulating character traits, narrative role, and specific knowledge from the AV media.
   Output: Character-specific prompts that guide the LLM in generating accurate and contextual responses during user interactions.

### User Interaction and Chatbot Response Generation:

Chatbot Conversations:
   User Input: Queries or requests related to the AV media.
   Process: The system uses the character specific System Prompts and the fine-tuned LLM to generate responses. For dynamic information retrieval, RAG is employed to query the enriched dataset and external sources if necessary, ensuring responses are informed and contextually relevant.
   Output: Generated text that simulates conversation with the character, including references to specific scenes, dialogue, or actions from the AV media.
Function Calling for Media Retrieval and Playback:
   Process: When users reference specific scenes or actions, the system uses function calling to identify the relevant moment in the AV media. This is facilitated by querying the enriched dataset for matching time-coded descriptions.
   Output: Playback commands that cue the AV media to the specified scene or action for display in the user interface.

### User Outputs and Data Collection:

Recording User Interactions:
   Feature: Users can opt to record their chatbot interactions.
   Output: Audio or text files capturing the conversation, which can be used for creating podcasts or social media content.
Data Collection for Profile Building:
   Process: During interactions, chatbots can pose questions to users, collecting data on preferences, interests, and feedback.
   Output: User profiles are updated with new data to refine future interactions, enhancing personalization.
Localization and Personalization:
   Process: Chatbots access real-time data (e.g., film showtimes, local events) and user profile information to tailor conversations. This includes integrating localized information such as merchandise offers and ticket availability.
   Output: Personalized chatbot responses that reflect the user's location, preferences, and past interactions.

### UI and Lifelike Interaction Enhancements:

To elevate the user experience, Reeltalk incorporates advanced visual and auditory features within the chatbot interface, creating lifelike animations and natural-sounding voice responses. This section outlines the technical implementation of these features, enhancing the realism of interactions with the character chatbots.

### Visual Animation Models:

Speaking Animation:
   Process: An image model is developed to animate the chatbot character while it is speaking. This model uses keyframes from the AV material or custom animations designed to match the character's speech patterns and emotions.
   Output: During conversation, the chatbot's visual representation moves in sync with its spoken responses, including mouth movements and facial expressions corresponding to the dialogue's emotional tone.
Idle Animation:
   Process: A separate model is created for idle animations, simulating behaviors such as blinking, nodding, and subtle movements to convey attentiveness and thought. These animations are triggered during silent waiting periods, enhancing the character's lifelike presence.
   Output: When the chatbot is not actively speaking, it displays natural idle behaviors, maintaining engagement and realism in the user interaction.

### Auditory Features and Voice Model:

Voice Model Training:
   Input: Audio samples from the AV material featuring the character's voice, supplemented with other relevant audio materials to enrich the voice dataset.
   Process: These audio samples are used to train a voice model specific to each character. This model employs deep learning techniques to capture the unique vocal characteristics, including tone, pitch, and cadence.
   Output: A highly realistic voice model that can replicate the character's speech for generating responses.
Conversational Interaction:
   User Input Methods: Users can interact with the chatbot using typed questions or a speech-to-text interface, accommodating diverse user preferences and accessibility needs.
   Response Generation: The chatbot uses a text-to-speech (TTS) system integrated with the trained voice model to convert generated text responses into spoken dialogue. This ensures that responses not only match the character's way of speaking in terms of language but also mimic their voice for an authentic auditory experience.

### Implementation Considerations:

Synchronization: Ensuring tight synchronization between the voice model's output and the speaking animation is crucial for maintaining the illusion of a lifelike conversation. Adjustments in animation timing may be required to match the speech speed and pauses in the generated voice.
User Interface Design: The chatbot UI is designed for ease of use, with clear options for users to switch between typing and voice input. Visual cues indicate when the chatbot is “listening” or processing, enhancing user engagement.
Performance Optimization: The visual and voice models are optimized for real-time performance, ensuring that animations and voice responses are generated without noticeable delays, contributing to a fluid and natural conversational experience.
Accessibility and User Preferences: Options are included for users to adjust the volume, speed of speech, and to enable subtitles for the voice responses, accommodating users with different accessibility needs and preferences.

By integrating these advanced visual and auditory technologies, Reeltalk delivers a compelling and immersive experience, allowing users to interact with their favorite characters in a manner that closely mimics real-life conversations. This technical approach not only enhances user engagement but also sets a new standard for interactive chatbot applications.

### Technical Overview:

Reeltalk is designed to enable creators to easily create Multi-Modal Characters from various inputs that are trained to create a custom character that meets a certain persona and overall character as designed by the creator. These Multi-Modal Characters interact with users in multiple chatbot style interactions that include a Zoom-like interface where the user interacts on a digital screen to a physical humanoid robot interface that interacts with the user like another human. Multi-Modal Characters can also simulate characters learned from audiovisual (AV) media such as films and TV shows. The application leverages a combination of Visual Interpretation AI, Retrieval-Augmented Generation (RAG) (see Bratanic, Melz and Suresh), Low-Rank Adaptation (LoRA) (see Hu et al., Github page at https://github.com/cccntu/minLoRA by Jonathan Chen dated 2023 (herein after Chen) and web page entitled “Code LoRA From Scratch” at https://lighting.ai/lighting-ai/studios/code-lora-from-scratch by Sebastian Raschka dated 2023 (hereinafter Raschka)), and function calling to provide rich, interactive experiences.

This disclosure further provides technical specifications for training and using a combination of models that process inputs, including Large Language Models (LLMs) (see web page entitled “GPT-3 is No Longer the Only Game in Town” at: https://lastweekin.ar/p/gpt-3-is-no-longer-the-only-game#:˜text=Take%20together%2C%20these%20factors%20mean,costly%20 and%20difficult%20to%20train by Andrey Kurenkov dated 2021 (herein after Kurenkov), articled entitled “GPT now supported with Transformer Models using CUDA 11.8 and cuDNN 8.6!” by David Brown dated 2022 (hereinafter Brown 1), article entitled “ChatGPT architecture now supported with Encoder/Decoder Transformer Models using CUDA 11.8 and cuDNN 8.8!” also by David Brown dated 2023 (hereinafter Brown 2), Github page at GitHub:karpathy/llama2.c by Andrej Karpathy dated 2023 (herein after Karpathy) and article entitled “Understanding Llama2.c and ChatGPT—A Visual Design Walkthrough” by David Brown dated 2024 (hereinafter Brown 3)), AI voice to text models, image to text models and video to text models that are used to process multi-modal inputs that include text from chat dialogs, movies scripts, audio video inputs and live cameras used to give the chatbot real-time context.

### Multimodal Chatbot:

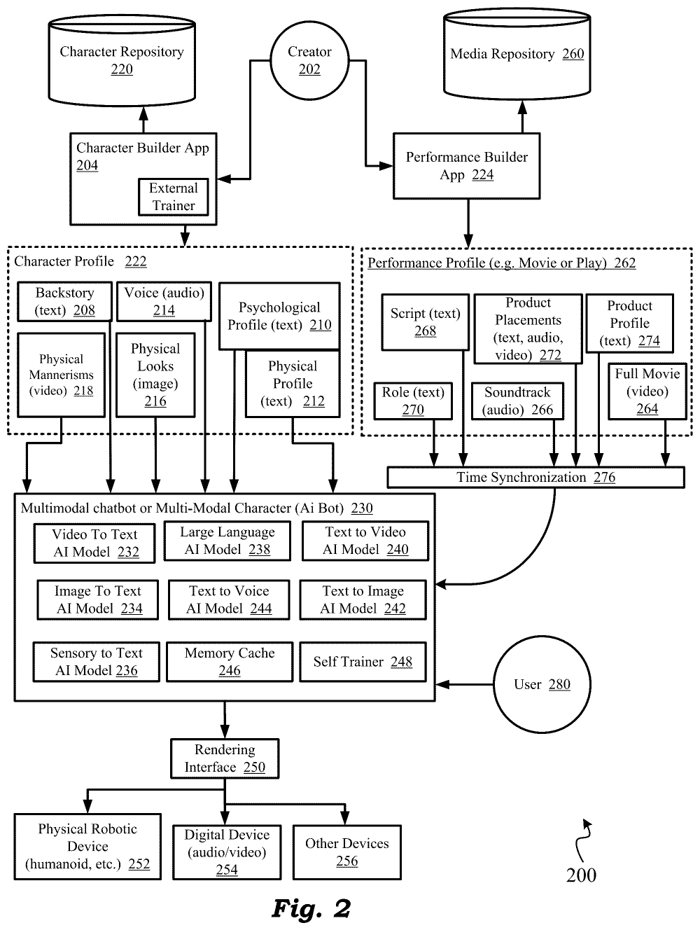

The systems and methods of the present invention will be understood by first reviewing a multisensory pod of a preferred embodiment as shown in FIG. 2. FIG. 2 illustrates an instant multimodal chatbot/ChatBot/chatbot system 200 that comprises several components and modules as shown. There is a creator user or simply creator 202 who creates an overall chatbot persona using Character Builder App 204. Optionally, creator 202 may also use Performance Builder App 224 to train an existing chatbot to play a specific role, such as an actor role in a movie, or singer role in a concert.

The main components making up the system are described as follows.

Creator 202: The creator is a person (or could even be another intelligent chatbot) who creates the persona of the multimodal chatbot. To create the persona, creator 202 provides or creates backstory text 208, psychological profile 210 and physical profile 212 including emotional profile, voice of the chatbot 214, physical look images (i.e. physical pos images for physical looks) 216, physical mannerism videos 218 in order to show personality, and other information used to define the character and knowledge of the chatbot.

Character Builder App 204: this software module/application is an editing and developing environment that allows the creator to build the features of the chatbot, train the chatbot and evaluate the trained features making up the Character Profile. This development cycle continues until the creator is satisfied with the chatbot.

Character Repository 220: this persistent storage (such as a Database) contains one or more character profiles 222 that are used to build instant multimodal chatbots. The various attributes in a character profile 222 are further enumerated below and shown in box 222 in FIG. 2. Persistent Storage 220 stores the features, physical attributes and personality characteristics required for the creation of an instant multimodal chatbot. Character Repository 220 also stores fully trained chatbots with each chatbot stored with version information for data management.

Character Profile 222: the character profile contains all information used to train the chatbot, including backstory text 208, physical profile and attributes text 212, psychological profile and attributes text 210, voice audio 214, images of physical features and pos/looks 216, video(s) of mannerisms 218 for personality and body language communication features.

Multimodal chatbot 230: this is the actual chatbot that comprises several large AI models, including one or more AI models used to process both inputs to the chatbot and outputs generated by the chatbot. The following sub-features are used within the multimodal chatbot:
Video to text model (VTM) 232: VTM 232 is used to convert visual or lidar video data to text descriptions that are then sent to the Large Language Model for context.
Image to text model (ITM) 234: ITM 234 is used to convert image data to text descriptions that are then sent to the Large Language Model for context.
Sensory to text model (STM) 236: STM 236 is used to convert sensory data from hardware sensors such as touch, velocity, humidity, temperature, etc., to text descriptions that are then sent to the Large Language Model for context.

The text input generated by the models above is then converted to tokens which are typically word pieces or characters. In alternative embodiments, each model converting from an input to text, could also just convert directly to tokens for efficiency. Thus, in such alternative embodiments, one would have a video to token model, an image to token model and a sensory to token model.
Large Language Model (LLM) 238: LLM 238 is used to process inputs and output responses and actions in either a generative manner or chat-style dialog. The LLM is the main driver of the other models used by the chatbot.
Text to video model (TVM) 240: TVM 240 is used to convert text responses from Large Language Model 238 to generated video feeds that express ideas, show thoughts, or convey other ideas for entertainment, education, or conversation.
Text to image model (TIM) 242: TIM is used to convert text responses from the Large Language Model to generate images that express ideas, show thoughts, or convey other ideas for entertainment, education, or conversation.
Text to voice model (TVM) 244: TVM 244 converts the text LLM 238 outputs to an audio feed thus giving the LLM a voice allowing the chatbot to talk to other humans or chatbots alike.

In alternative embodiments, for efficiency, the models converting input text may directly convert tokens for efficiency. Thus, in such alternative embodiments, one would have a token to video model, a token to image model and a token to sensory model.

Memory Cache 246: memory cache 246 stores all interactions occurring within the chatbot including observations from video, audio, or text dialog. It is often desirable to have chatbots learn their context over time. One way in which the multimodal chatbot does this is to train at night all experiences stored within the Memory Cache during the day thus allowing the multimodal chatbot to clear the Memory Cache and start anew the next day, with newly learned knowledge that has been transferred from the Memory Cache into the LoRA enabled weights of each of its internal AI models.

Self-Trainer 248: Self Trainer module 248 is responsible for training the internal AI models with the new experiences and knowledge stored in the Memory Cache. These internal models include the above-taught video to text model, image to text model, sensory to text model, large language model, text to video model, text to image model and text to voice model. Once sufficiently trained, the Memory Cache may optionally be cleared to learn more new experiences and knowledge. Typically, such self-training updates the LoRA weights of each internal AI Model, leaving the original model weights untouched. Such a scheme then allows the creator to evaluate the evening training, giving them the ability to accept or reject the training results. It should be noted that LoRA is one technique of many used to merge two separate weight sets to get a desired outcome.

Rendering Interface 250: Rendering Interface 250 is a generic connection to various rendering platforms. Such an interface allows for a single multimodal chatbot to run or be deployed on many different physical or virtual platforms or devices. Such platforms may include digital screens, be in the back office without a screen, or run on a physical device such as a vehicle, farm equipment, industrial machine, spaceship, ship, aircraft, or even on a humanoid robot.

Physical Robotic Device 252: this rendering device 252 is a mechanical device that has physical capabilities of movement in the physical world and may include humanoid robots, robotic dogs, vehicles, etc.

Digital Device 254: this rendering device 254 typically interacts with the user via digital screen such as a digital phone, computer, TV, movie theater, or other digital touch device.

Other Devices 256: other rendering devices 256 are possible as well. For example, the multimodal chatbot may learn to interact with other computer systems with no need for physical or display capabilities.

Performance Builder App 224: Performance Builder App 224 allows the creator to create new performances in which an existing or new multimodal chatbot is trained to perform. For example, a full-length movie digested by the Performance Builder App creates new multimodal chatbots based on the characters in the movie. Each chatbot is trained with the physical, psychological, and emotional features learned from the movie, trained with the voice and overall personality of each character.

Media Repository 260: Media Repository 260 contains the media elements used by Performance Builder App 262, which may include full length movies 264, soundtracks 266, songs, movie or play scripts 168, character background or role text 270, product placements 272, product profile text 274, etc.

Performance Profile 262: Performance Profile 262 contains data describing the overall performance taking place including the specific movie, specific soundtrack, specific character descriptions and background for a specific performance that it to be used for training. One or more performance profiles 262 along with their various attributes are stored in a persistent storage in media repository 260. These attributes were already enumerated above and shown in box 262 in FIG. 2. Performance Profile 262 also contains a Time Synchronization component or module 276 used to time synchronize all aspects making up the performance. For example, the script and full-length movie, soundtrack and other temporal elements must all be synchronized in time with time signatures to allow for behavior and event learning from the input data.

User 280: User 280 is the person (or even another chatbot) who interacts with the multimodal chatbot.

Furthermore, in this disclosure we will explore the mechanics used to build and retain personal relationships between the user and the chatbot.

### Use Cases:

This section describes the common use-cases related to the multimodal chatbot.

### User Interactions:

A user's interaction with the multimodal chatbot commonly consists of talking or texting to the chatbot much in the same way two people would dialogue with one another. However, depending on Rendering Interface 250 of FIG. 2, such communication may take many different forms. For example, one might converse with a Physical Robotic humanoid Device through sign language hand signals. A headless Display Device may converse with another multimodal chatbot merely through digital signals.

### User Interaction Initialization:

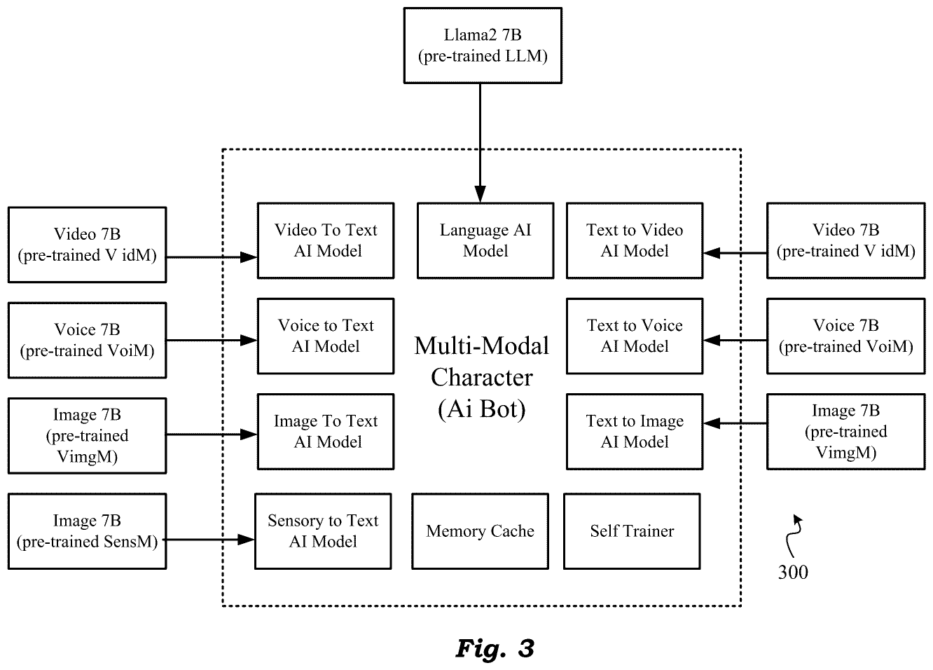

During initialization, all pre-trained base models are loaded into the multimodal chatbot for the video to text, voice to text, image to text and sensory to text models. Next, the text to video, text to voice, and text to image models are loaded. And finally, the Large Language Model (LLM) pre-trained base-model is loaded. Alternatively, the multimodal chatbot may use cloud-based models already loaded at a cloud location, but this operating mode requires a network connection to the cloud via wi-fi, 5g or another network. FIG. 3 shows a block diagram 300 of such a user interaction initialization based on the instant principles.

Simpler versions of the multimodal chatbot can run with a subset of the models described above. For example, a chat-only bot may only load the main Large Language Model (LLM), whereas others may load the LLM plus combinations of the other models depending on the overall needs of the chatbot. Advanced configurations support hot-loading of models where sub-models like the Text-to-Video model are only loaded when needed then later discarded when not needed. Such hot-swapping can help conserve resources on the chatbot.

### User Interaction:

Once initialized, the multimodal chatbot interacts with the user via one or more of the various inputs supported.

There are many ways to interact with the multimodal chatbot, but three main sources of inputs feed into the chatbot. The most direct interactions occur when the user sends text messages directly to the chatbot which produces a response. However, the user may also converse with the chatbot using a webcam or other video device, Microphone for audio and other sensors for sensory feedback. In addition to User inputs, Environmental inputs may also feed into the video, audio, and sensory input streams.

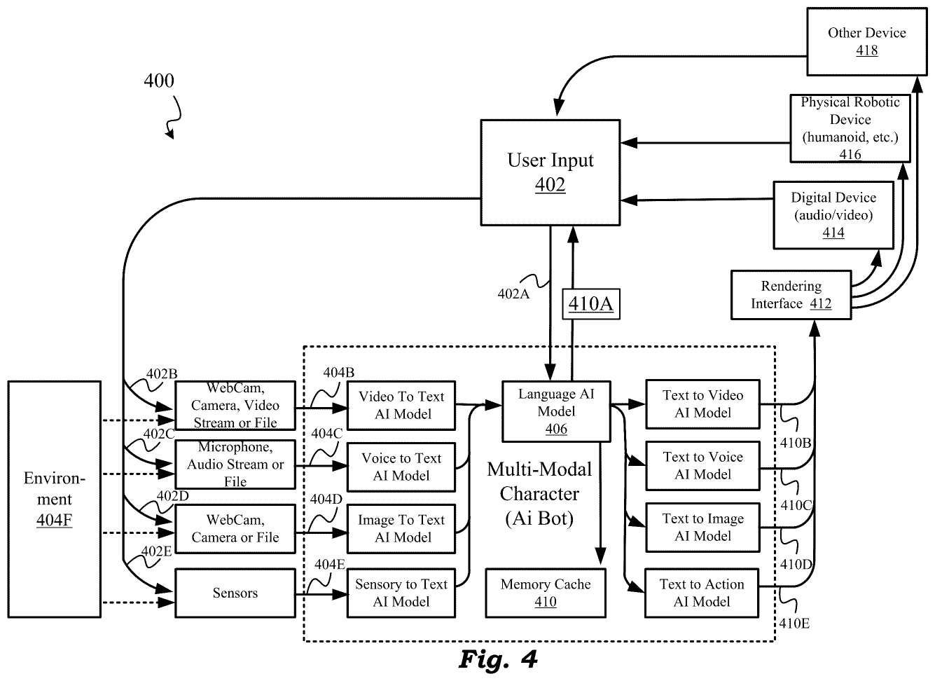

FIG. 4 represents a composite diagram 400 showing the various elements as well as the necessary steps required to implement this aspect of the present design.

As shown by process boxes marked by respective reference numerals in FIG. 4, when interacting with the multimodal chatbot the following steps occur.
402A: The user may opt to directly send text messages to the chatbot that are then processed by the Large Language Model.
402B: Alternatively or in addition, the user may interact with the chatbot using a video or audio device, send a picture to it, or send inputs via one of the sensory inputs.
404B: The above inputs allow the chatbot to use the video AI models to understand what it sees by running its internal Video to Text AI model to detect the video contents and convert descriptions of those contents to textual input that is then sent to the Large Language Model as context or as prompt input
402C: Alternatively or in addition, the user may talk to the chatbot where the audio sounds are picked up by a microphone.
404C: The above audio is fed to the chatbot's internal Voice to Text AI Model and converted into textual inputs sent to the chatbot.
402D: Alternatively or in addition, the user may also converse with the chatbot via a Webcam, Camera, or other video stream.
404D: Image data is converted to text by Image to Text AI model for describing the contents of the image and then used as context or as a prompt by the Large Language Model.
404E: Sensory inputs are also provided by the various sensors.
404F: These inputs are then converted to text by Sensory to Text AI Model and then sent to the Large Language Model as context or prompt input.
Non-User, Environmental inputs may also be mixed with or sent separately to the video stream giving the Large Language Model environmental context. Similarly, non-User Environmental inputs may include audio that is processed and sent as text context input to the Large Language Model. Environmental image data is processed similarly and to give the Large Language Model environmental context. Environmental sensory data, such as temperature, velocity, acceleration, humidity, geothermal activity, geomagnetic input, gravitational input, radiation input, atmospheric pressure, touch input, or other sensory inputs may be fed and processed by the internal Sensory to Text AI Model and fed to the Large Language Model for environmental context.
406: Upon receiving all context and prompt inputs (system and/or user) the Large Language Model processes the inputs and produces the outputs in a generative manner. Each response is generated until either cancelled or an EOS (end of sentence is received).
408: The generated response may be sent back to the user as text.
410: Each response is stored in the Memory Cache that is either stored locally or at a location in the cloud or other network.
410B: Alternatively, the text may be converted back into a video stream using the Text to Video AI Model.
410C: Text outputs may also be converted into voice output using the Text to Voice AI Model thus allowing the multimodal chatbot to talk to the user.
410D: The text outputs may be converted to an image using the Text to Image AI Model and sent to the user or Display Device.
410E: The text outputs may also be converted to specific actions using the Text to Action AI model thus giving the chatbot the ability to direct Physical Robotic Devices, or Other Devices to take a physical action, for example.
412: The outputs are sent to the Rendering Interface which routes all output data to one or more active Rendering Device(s). One type of rendering device may be a Debugging Device used to help diagnose outputs produced by the multimodal chatbot.
414: Digital Devices display text, video, images, and audio outputs to the user, or collectively to a group of users such as at a Movie.
416: Physical Robotic Devices, such as a humanoid or vehicle, use the outputs that they are equipped to manage. For example, a humanoid device may perform action outputs and conduct those actions, speak voice outputs through a speaker and even display video and image and or text outputs on a display.
418: Depending each Other Device, outputs are rendered depending on the capabilities of each such Output Device.

### Creating Character Profiles:

Character profiles define the overall character of a given chatbot's persona and may be created off-line by the creator (a person such as the user designer).

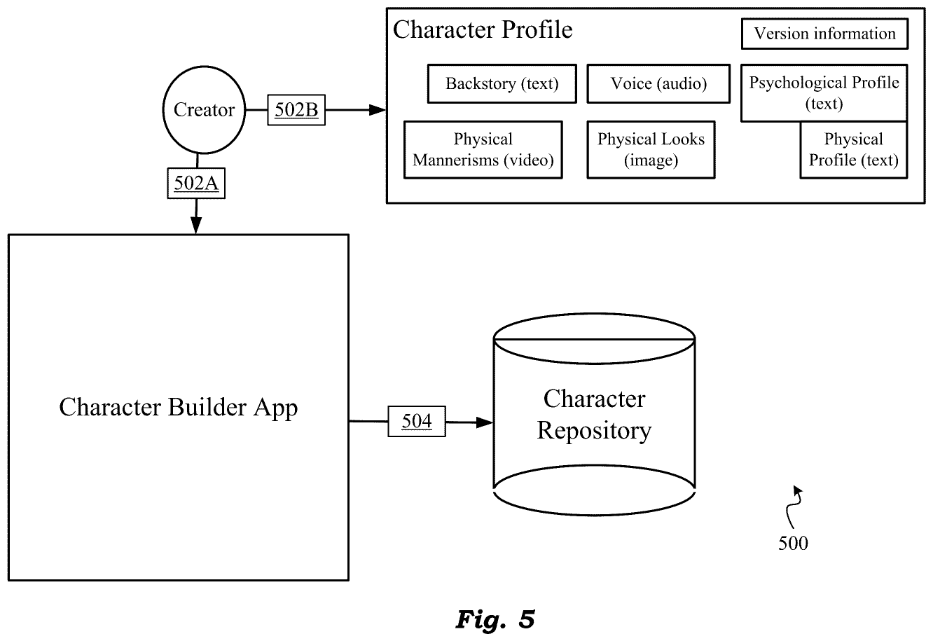

The instant multimodal chatbots use the character profile as input to the system or user prompt to let the LLM know what the persona of the chat-bot should be. For example, a user creator may want to create a ‘Snoop Dogg’ profile for a profile licensed from the Snoop Dogg personality. The Character Builder App would be used to define all aspects of the profile including look mannerisms, method of speaking, linguistic characteristics, etc. FIG. 5 illustrates a block diagram 500 and associated steps for the above aspect of creating a character profile based on the instant principles.

Per steps/boxes 502A-B, the creator uses the character builder app to create a character profile. The character profile is stored in the character repository per step 504 and above teachings. In addition, a performance profile may be created that describes all aspects of how a given character profile (or group of character profiles) are to perform in a given play, movie, musical performance, or other type of performance. For example, the performance profile could define the dance moves, lyrics, singing tone, musical instruments used, signing method, mimicked song, etc. of a given performance. For a movie, the performance profile would include all aspects of the movie including soundtrack, characters, script, behaviors, scene descriptions, location descriptions, character interactions, etc., and all other aspects necessary to recreate the movie.

The character profile and/or performance profiles are then fed into the LLM's system prompt or user prompt to let the LLM know the context of the following discussion and interactions.

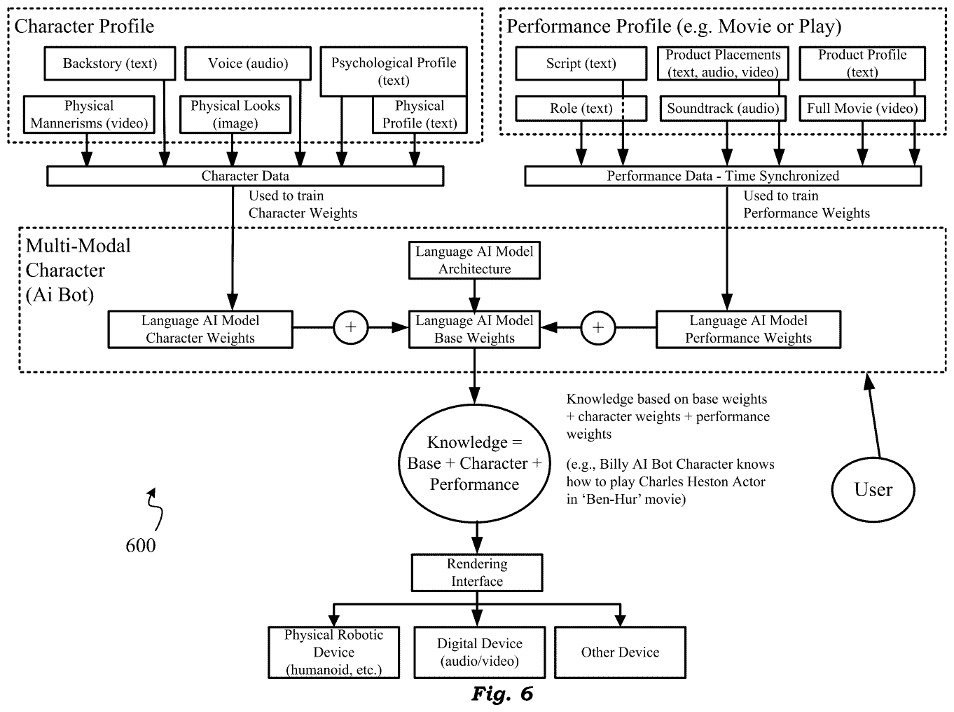

With the character and performance profiles as input, the LLM can then direct the rendering interface to ‘play out’ the actions desired. For example, a physical robot may be directed with the script to speak in a given tone of voice and the physical actions to take. The above aspect of the design is illustrated in a block diagram and associated steps 600 as shown in FIG. 6.

### Training:

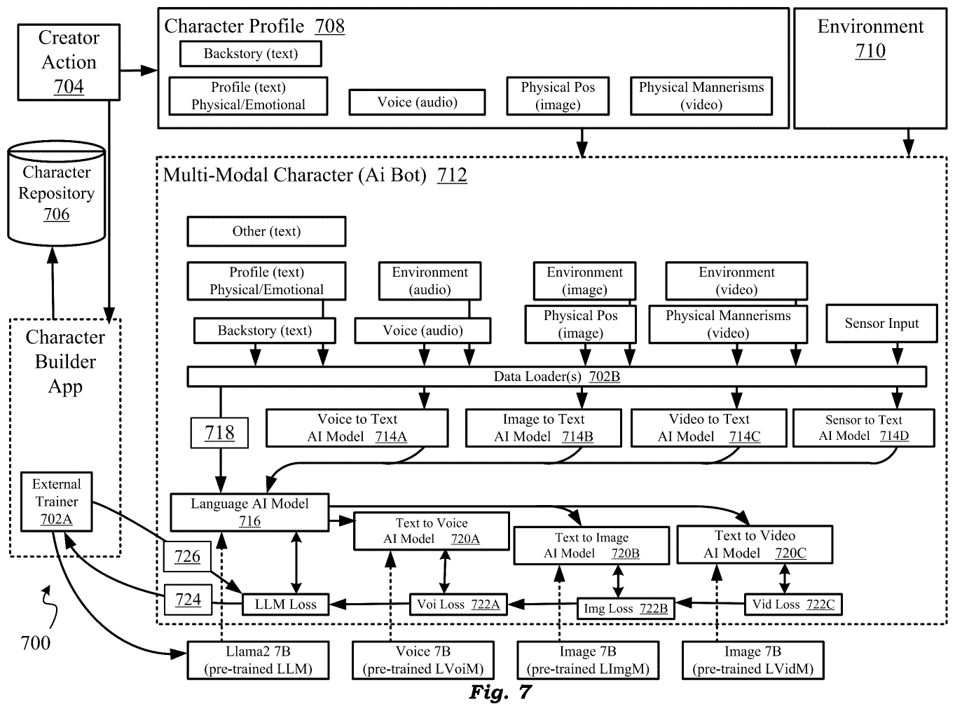

During training, the internal models of the multimodal chatbot are fine-tuned to a specific character profile and optionally specific environment. Each internal model is initialized using a pre-trained large model used to process language (text), video, images, voice, and even sensory data. FIG. 7 represents a composite diagram 700 showing the various elements as well as the necessary steps required to implement this aspect of the present design.

As shown by process boxes marked by respective reference numerals in FIG. 7, the following steps occur during training.
702A-B: First, the reference models are loaded for the Large Language Model, Text-to-Voice Model, Text-to-Image Model, Text-to-Video Model, optionally a Text-to-Action Model, Voice-to-Text Model, Image-to-Text Model, Video-to-Text Model and optionally a Sensor-to-Text Model. Data Loaders are used to organize the data into test, train, and validation data sets. On each cycle, if more than one Data Loader is used, they are synchronized.
704: Next the creator either creates a new Character Profile or loads an existing one from the Character Repository.
706: The Character Repository may also store resources used to build new and alter existing Character Profiles.
708: The Character Profile is sent to the Multi-Modal Character chatbot 712 for training.
710: Optionally character profile is sent with Environmental data.
714A: During the training cycle when a Voice to Text model is used, and voice input exists, it is fed into the Voice to Text model which produces the output Text. More than likely this model has already been pre-trained and therefore does not take part in the learning at this point but merely converts the voice input into text.
714B: Similarly, the image to text model is fed any image inputs if they exist and they are converted to text as a description of the image inputs.
714C: Video inputs if they exist are converted to text as a description of the video inputs.
714D: And if sensory inputs exist, they are sent to and converted to text by the Sensory to Text AI Model.
716: All text converted inputs from the voice, image, video, and sensory inputs are sent to the Large Language Model.
718: Any direct text inputs (system or user prompts, for example) are also sent to the Large Language Model.
720A: Text outputs are optionally sent to the text to voice model that converts the text back to audio output. Optionally, if the text to voice model participates in the learning, the Voi Loss is saved and combined with the other loss values.
720B: Similarly, the text outputs are optionally sent to the text to image model that converts the text to an image output. Optionally, if the text to image model participates in the learning, the Img Loss is saved and combined with the other loss values.
720C: Similarly, the text outputs are optionally sent to the text to video model that converts the text to video output. Optionally, if the text to video model participates in the learning, the Vid Loss is saved and combined with the other loss values. Other, conversion models may also participate in the learning, such as a Text to Action model used to direct a Physical Robotic Device to conduct an action.
722A-C: The LLM Loss value from the Large Language Model is combined with the other loss values. Commonly the LLM loss values are calculated using CrossEntropyLoss (see article entitled “Understanding Categorical Cross-Entropy Loss, Binary Cross-Entropy Loss, Softmax Loss, Logistic Loss, Focal Loss and all those confusing names” by Raul Gomez dated 2018, hereinafter (Gomez)) as the LLM outputs a set of probabilities used to calculate the next output token.
724: The combined loss values are passed to the External Trainer managing the training process.
726: On the backward pass, only the LoRA weights in each of the models participating in learning are updated by the optimizer thus speeding up the training and only fine-tuning to the new information. (see Belkada et al., Bratanic, Chen, Hu et al., article entitled “LoRA Fine-Tuning Simplified: A Step-by-Step Guide for Beginners” by Shanmukha Karthik dated 2023 (hereinafter Karthik), Raschka, article entitled “Practical Tips for Finetuning LLMs Using LoRA (Low-Rank Adaption)” by Sebastian Raschka dated 2023 (hereinafter Raschka 2), article entitled “Train from scratch and Fine-tune an Instruct Llama2 model in PyTorch” by Cindy Sridykhan dated 2023 (hereinafter Sridykhan), Github page GitHub: cindysridykhan/instruct storyteller-tinyllama2 at: https://github.com/cidysridykhan/instruct_storyteller_tinyllama2?tab=readme-ov-file also by Cindy Sridykhan dated 2023 (hereinafter Sridykhan 2) and article entitled “Understanding Instruct Llama2 and Fine-Tuning with LoRA
A Visual Design Walkthrough” by David Brown dated 2024 (hereinafter Brown 4)).

### Training for Performance:

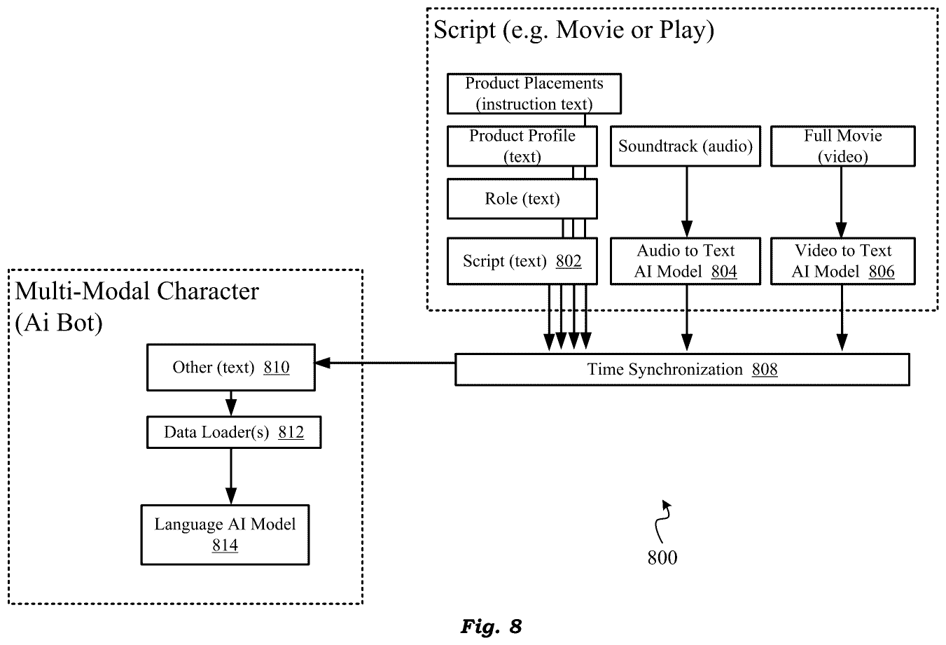

When training for a performance, and existing or new multimodal chatbot can be trained with additional performance data such as the script from a movie or the entire movie itself. FIG. 8 represents a composite diagram 800 showing the various elements as well as the necessary steps required to implement this aspect of the present design.

As shown by process boxes marked by respective reference numerals in FIG. 8, when training with Performance related data, the following steps occur.
802: The performance textual data is collected and sent to the Time Synchronizer.
804: The audio data is sent to the Audio to Text Model, converted to text and sent to the Time Synchronizer.
806: The video data (such as a full movie, sub-movie, commercial, etc.) is sent to the Video to Text AI Model and converted to text that is sent to the Time Synchronizer.
808: The Time Synchronizer synchronizes all text data with time stamps and aligns the data.
810: All time-synchronized data is sent as Other Text input in the training process described in the previous section.
812: A Data Loader loads this data and sends it along with the other input text.
814: The text is sent to the Large Language Model for training.
   Reinforcement Learning with Human Feedback Training:

In some cases, the creator may want to build the ideal character for a given character type. For example, the creator may want to create the best studly nerd character. However, the creator may not be sure what that character is until they see the character take shape. To create such a character, the reinforcement learning with human feedback (RLHF) training is used. This training is a two-step process. In the first step, the Policy AI Model is trained to learn what the creator likes and in the second step that model is used to fine-tune the internal multimodal chatbot models.

### Training the Policy Model:

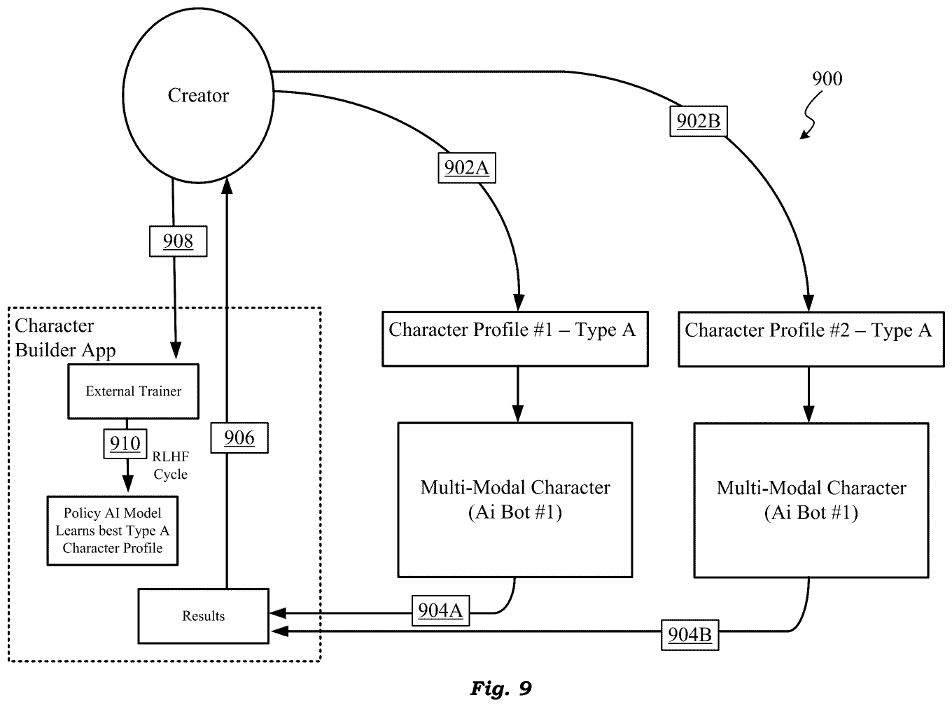

The policy model is trained to learn what style the creator likes by presenting to the creator a number of styles created by two separate Multi-Model chatbots, each running their own distinct AI models. FIG. 9 represents a composite diagram 900 showing the various elements as well as the necessary steps required to implement this aspect of the present design.

As shown by process boxes marked by respective reference numerals in FIG. 9, the following steps occur when training the policy model with RLHF:
902A-B: First the creator starts two Multi-Modal Characters running with initial Character Profiles loaded where each profile is different but targets the desired Character Type.
904A-B: Each Multi-Modal Character is prompted with the same prompt but with slightly different Character Profiles and each outputs their results which are sent back to the Character Builder App.
906: The two different results are displayed back to the creator.
908: The creator chooses the result they like best and sends their choice back to the Character Builder App.
910: The External Trainer then updates the Policy AI Model through a small batch training or adds the results to a dataset that is used in a batched training cycle.

Steps 902-910 continue over numerous iterations until the Character Profile desired is found. Given that this process can take time, using Synthetically Generated Character Profiles can help automate the process where the user is shown numerous results to choose from on each cycle thus speeding up the training process. However, since we are using LoRA fine-tuning in this process, the training is much faster than training from scratch. On each training cycle, the policy model (see article entitled “Illustrating Reinforcement Learning from Human Feedback (RLHF)” by Nathan Lambert dated 2022 (hereinafter Lambert et al.)) is trained to output a scalar value representing ‘how’ good the results produced by the winning model are. To that end, the user is often asked to give the best result a ranking say from 1-5. This ranking is used to train the policy model to output a ranking on each result it receives which is later used to fine tune the multimodal chatbot's internal models.

Fine Tuning Multi-Modal Character Chatbot with Policy Model:

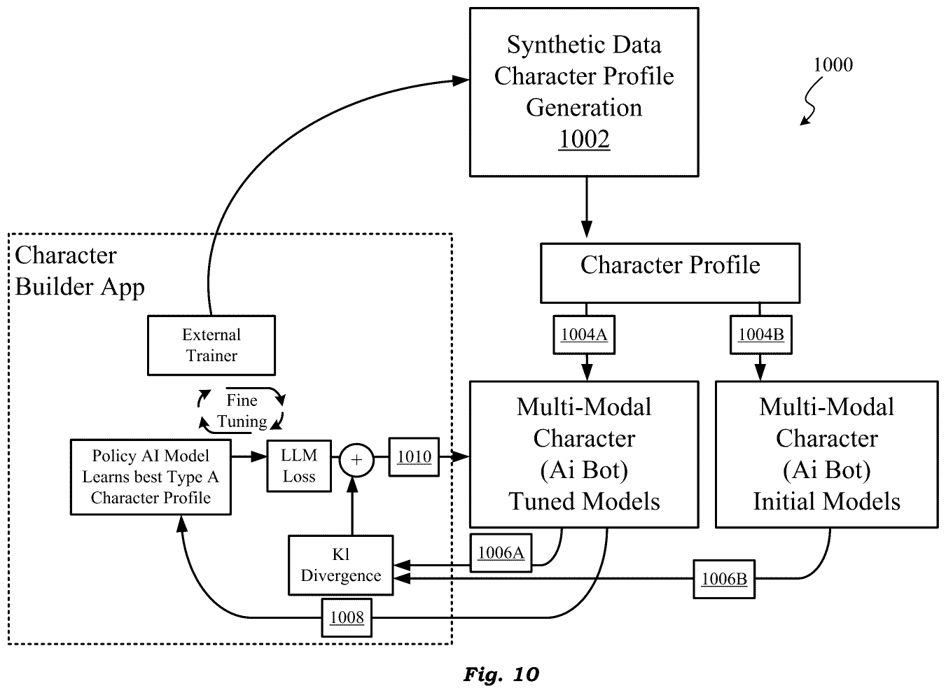

Once the policy model is sufficiently trained, we are ready to finetune the Multi-Modal Character chatbot with it. FIG. 10 represents a composite diagram 1000 showing the various elements as well as the necessary steps required to implement this aspect of the present design.

As shown by process boxes marked by respective reference numerals in FIG. 10, the following steps occur when fine-tuning the multimodal chatbot with the already trained policy model.
1002: First the External Trainer directs the Synthetic Character Profile Generator to create a new Character Profile that is like a known character type. The Character Profile is created with a synthetically generated prompt.
1004A: The character profile is sent to the multimodal chatbot being fine-tuned.
1004B: The character profile is also simultaneously sent to the multimodal chatbot with the initial models.
1006A-B: The results from both the fine-tuned and initial chatbot models are sent to the KL Divergence processing which is used to make sure the fine-tuning does not stray too far from the original model causing hallucinations.
1008: The result from the fine-tuned model is also sent to the trained policy model which outputs a scalar rating for the results.
1010: The policy model's scalar rating is added to the KL Divergence calculation and used as the loss for the Reinforcement fine-tuning of the multimodal chatbot being fine-tuned.

For more information on the general RLHF process (see Lambert et. al.).

### Use Cases—Building Relationships:

This section describes the common use-cases related to building a personal relationship with a Multi-Modal Chat-Bot.

### User Interactions:

A user's interaction with the Multi-Modal Chat-Bot commonly consists of talking or texting to the Chat-Bot much in the same way two people would dialogue with one another. However, depending on the Rendering Interface used, such communication may take many different forms. For example, one might converse with a Physical Robotic humanoid Device though sign language hand signals. A headless Display Device may convers with another Multi-Modal Chat-Bot through merely through digital signals.

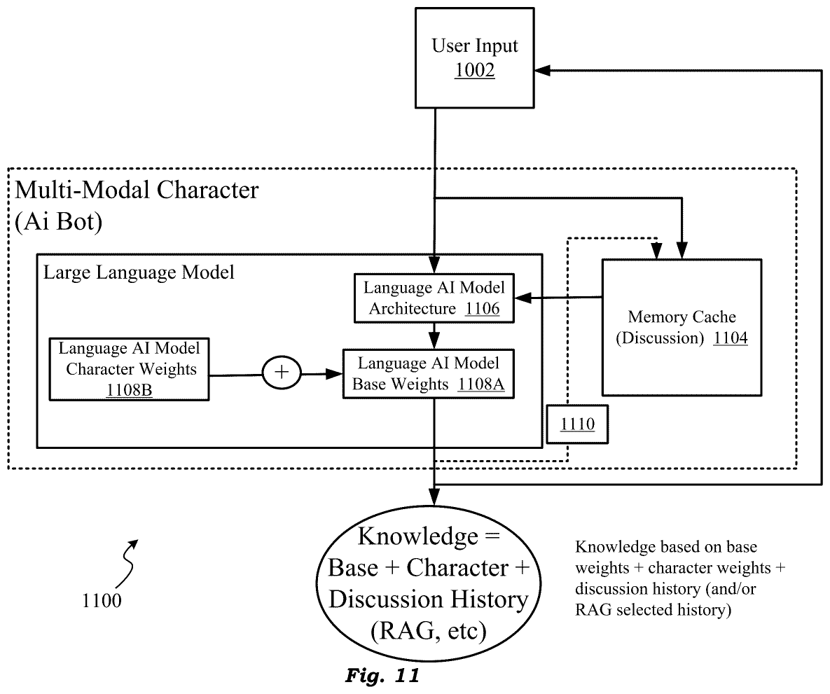

During these interactions with the user, or even the environment itself, the Chat-Bot continually stores all interactions in one or more memory caches that are stored in memory, or on another persistent storage such as a solid-state drive, or off-site cloud storage location. FIG. 11 represents a composite diagram 1100 showing the various elements as well as the necessary steps required to implement this aspect of the present design.

As shown by process boxes marked by respective reference numerals in FIG. 11, the following steps occur when a user interacts with a chatbot.
1102: The user directly sends prompts in text form to the chatbot. Alternatively, text (or direct embeddings) from one of the various input AI models (e.g., video to text, image to text, sensory data to text, etc.) are input to the chatbot. Note, such multi-modal inputs may be input simultaneously by separating each using special tokens like the BOS (beginning of sentence) and EOS (end of sentence) special tokens currently used by large language models to designate input blocks. The inputs are sent to the Large Language Model while simultaneously being sent to the discussion memory cache for later processing and knowledge building.
1104: In addition to the above inputs, the discussion memory cache may also be used as an input to the chatbot either directly or with a RAG type selection method (see Melz and Suresh). These inputs are also tokenized (if not already in token form) and converted into embeddings (if not already in embedding form).
1106: The Large Language Model takes the above inputs and, if not already in embedding form, converts the inputs into embeddings that then flow through the model.

This initial conversion process may take the form of converting text to tokens to embeddings, or if tokens are sent to the LLM, converting from tokens to embeddings, or if embeddings are input directly, they are used without conversion.
1108A-B: Once in an embedding form, the data is processed by running the embedding data through the LLM in a forward, inference pass which uses the Language AI Model base weights or simply base weights combined with the LoRA weights using the LoRA inferencing as discussed by Brown 4 and Hu et al. The model inferences the data, often using a transformer-based model like those used by other GPT and Llama models (see Brown 1 and Brown 2).
1110: The inferencing produces output tokens which are then de-tokenized into text. The output tokens (and/or de-tokenized text) are then stored in the discussion memory cache while simultaneously being output to the user as de-tokenized text. When using the system with a non-human user (such as another chatbot), the output tokens may optionally be sent directly to the non-human user for efficiency.

### Relationship Training:

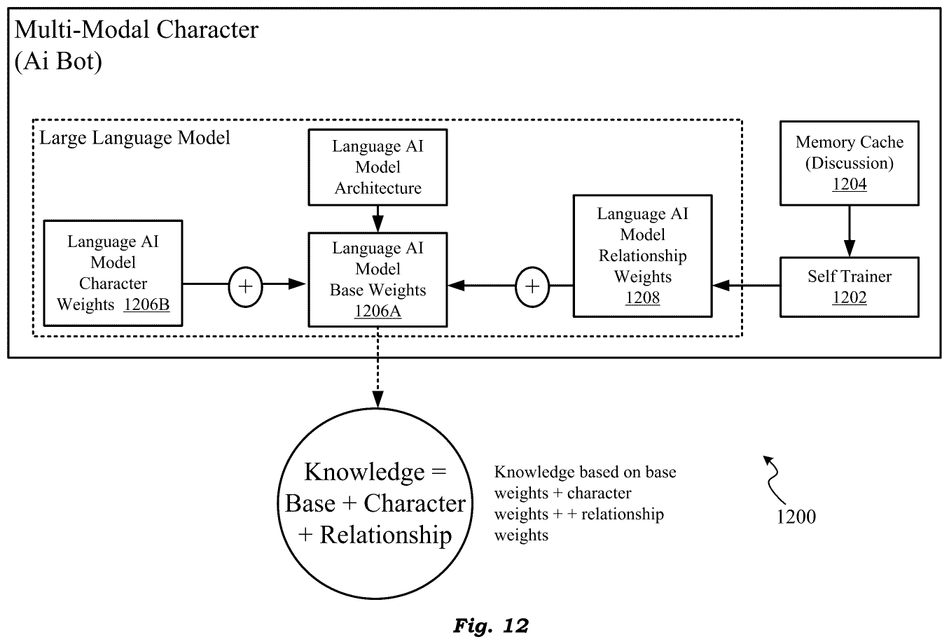

During the evening, or other non-interactive time periods where the user is not interacting with the chatbot, the knowledge stored in the discussion memory cache is used to train a second set of weights (e.g. LoRA weights) designated specifically to store personal, and often private, relationship knowledge borne out of previous discussions with a particular user. To do this, the memory storage contents are used directly to fine-tune a new set of LoRA weights that are later used in an additive manner similar to how the original LoRA weights are used (see Brown 2 and Hu et al.). FIG. 12 represents a composite diagram 1200 showing the various elements as well as the necessary steps required to implement this aspect of the present design.

As shown by process boxes marked by respective reference numerals in FIG. 12, the following steps occur when fine-tuning the relationship weights:
1202: The Self Trainer is responsible for training the Language AI Model relationship weights, which are preferably LoRA relationship weights.
1204: The current discussion memory cache contents, stored on a per user basis, are used to train the relationship weights much in the same way other weights (e.g. LoRA weights) are fine-tuned (see Brown 4, Karthik and Sridykhan). However, during the fine-tuning, only the discussion memory cache items for a specific user are used to fine-tune LoRA weights assigned to that user thus protecting the privacy of those discussions between the chatbot and the user. If, for example, the chatbot had discussions with multiple users between training sessions, specific and distinct LoRA weights are fine-tuned for each separate discussion using separate training sessions that fine-tune separate and distinct LoRA weights assigned to each user.
1206A-B: During the fine-tuning process, the Language AI Model base weights, and all other Language AI Model weights (e.g., character weights) are frozen.
1208: Only the specific relationship weights assigned to the user are fine-tuned.

### User Interactions After Relationship Fine Tuning:

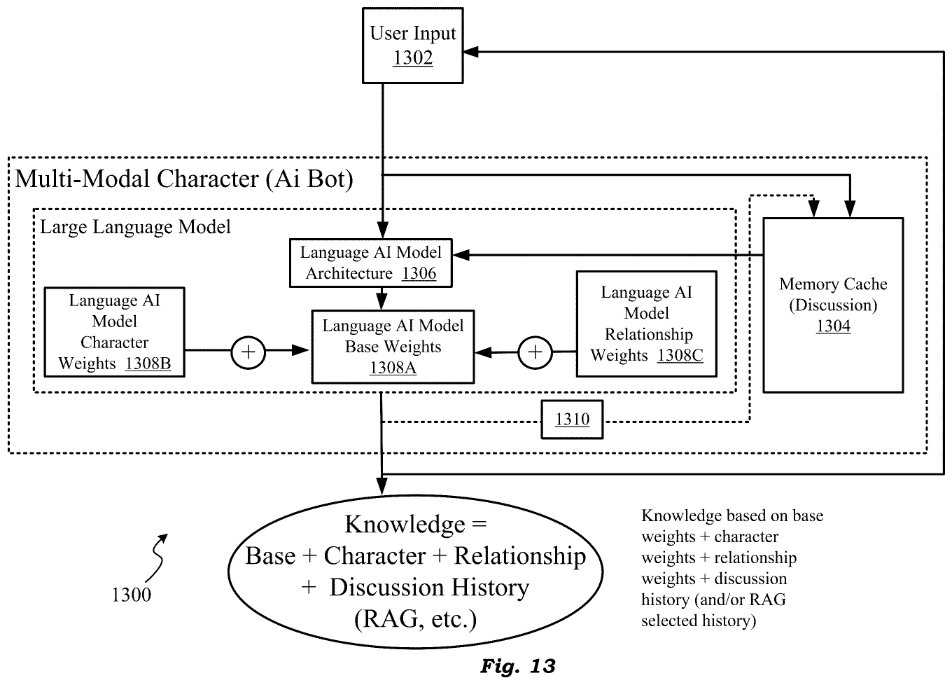

When a user interaction session occurs after fine-tuning the relationship weights, the fine-tuned weights are used in each future interaction during inference. FIG. 13 represents a composite diagram 1300 showing the various elements as well as the necessary steps required to implement this aspect of the present design.

As shown by process boxes marked by respective reference numerals in FIG. 13, the following steps occur when a user interacts with the chatbot after fine-tuning the relationship weights and clearing the discussion memory cache.
1302: Like before, the user directly sends prompts in text form to the chatbot. Alternatively, text (or direct embeddings) from one of the various input AI models (e.g., video to text, image to text, sensory data to text, etc.) are input to the chatbot. Note, such multi-modal inputs may be input simultaneously by separating each using special tokens like the way the BOS (beginning of sentence) and EOS (end of sentence) special tokens that are currently used by large language models to designate input blocks. The inputs are sent to the Large Language Model while simultaneously being sent to the discussion memory cache for later processing and knowledge building.
1304: In addition to the above inputs, the Memory Cache may also be used as input either directly or by using a RAG type selection method (see Melz and Suresh). These inputs are also tokenized (if not already in token form) and converted into embeddings (if not already in embedding form).
1306: The Large Language Model takes the inputs and, if not already in embedding form, converts the inputs into embeddings that then flow through the model. This conversion process may take the form of converting text to tokens to embeddings, or if tokens are sent to the LLM, converting from tokens to embeddings, or if embeddings are input directly, they are used without conversion.
1308A-C: Once in an embedding form, the data is processed by running the data through the LLM in a forward, inference pass which uses the Language AI Model base weights combined with the character weights and the newly fine-tuned relationship weights during the inferencing as discussed by Brown 4 and Hu et al. The character and relationship weights are stacked by adding the weight results (or directly adding the weights) of each together during the inferencing process. The model inferences the data, often using a transformer-based model like those used by other GPT and Llama models (see Brown 1 and Brown 2).
1310: The inference produces output tokens which are then de-tokenized into text that now consider the knowledge within the base weights+the knowledge within the character weights+the knowledge within the relationship weights. The output tokens (and/or de-tokenized text) are then stored in the Memory Cache while simultaneously being output to the Rendering Device as either de-tokenized text or direct tokens. The Rendering Device then renders the data as actions or conversation outputs (e.g., text output to the user reading a screen-based Rendering Device). When using the system with a non-human user (such as another chatbot), the output tokens may optionally be sent directly to the non-human user for efficiency.

### Environment Interactions:

In addition to interacting with users, the chatbot may also interact and learn from the environment for which the chatbot receives sensory inputs via hardware sensors. With some rendering devices, such as a Physical Rendering Device, environmental interactions may take place in a back-and-forth manner, where the chatbot curiously interacts with the environment to learn more about it. Alternatively, environmental inputs may constantly be input into the chatbot allowing it to learn from the environmental inputs.

Each chatbot can receive inputs from video, image, audio, and sensors thus giving the chatbot a much richer set of inputs than just direct textual input from a user. Inputs from each of these sources may automatically feed data into the chatbot continually and/or automatically, or in an interactive manner prompted by the chatbot. For example, a sensor may send temperature, humidity, wind, or other environmental sensory inputs to the chatbot giving it a better situational awareness. These inputs are processed in a comparable manner to user inputs in that they help the chatbot learn from each experience independently of user interactions.

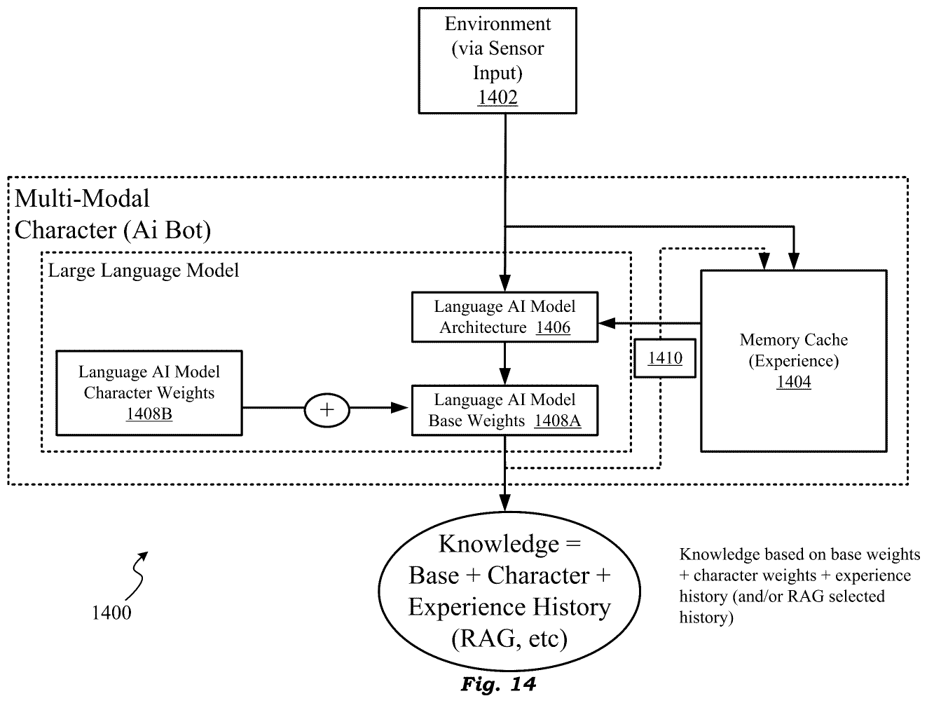

FIG. 14 represents a composite diagram 1400 showing the various elements as well as the necessary steps required to implement this aspect of the present design.

As shown by process boxes marked by respective reference numerals in FIG. 14, the following steps occur when the chatbot has environmental inputs or other types of interactions.
1402: The environmental inputs from sensors, video, audio, image, or other types of inputs are sent to the chatbot and either pre-converted to text, then to token and then to embedding or the chatbot is directly sent tokens that are then converted to embeddings, or the chatbot is directly sent the embeddings themselves.
1404: Optionally, text, embedding or raw input data stored within the experience memory cache are also sent to the Language AI Model for processing. These are also converted into embeddings and processed with the inputs from the step above.
1406: If not already in embedding form, the Language AI Model first converts the inputs into embeddings.
1408A-B: Internally, the Language AI Model uses both the Language AI Model base weights along with the character weights, which are preferably LoRA character weights, to process the outputs to the experiences from the environment which may be in the form of chatbot thoughts, interpretations, and musings on the experiences from the environment. For example, the character of one chatbot may not like chilly weather and react adversely to a cold environment, whereas another chatbot character may like chilly weather and react positively.
1410: The interpretations, musings or otherwise thoughts of the chatbot based on its environmental experiences are then stored back in the experience memory cache and optionally output to the user.

Optionally a RAG like selection may be used to select from the experience memory cache to optimize processing. For example, the chatbot may experience an initial gust of wind and think “that was strong, I better tell my Physical Rendering to brace itself.” Later when another gust of wind hits, the chatbot may use RAG to look-up wind-related topics from its experience memory cache allowing the chatbot to reuse the already learned knowledge.

### Experience Training:

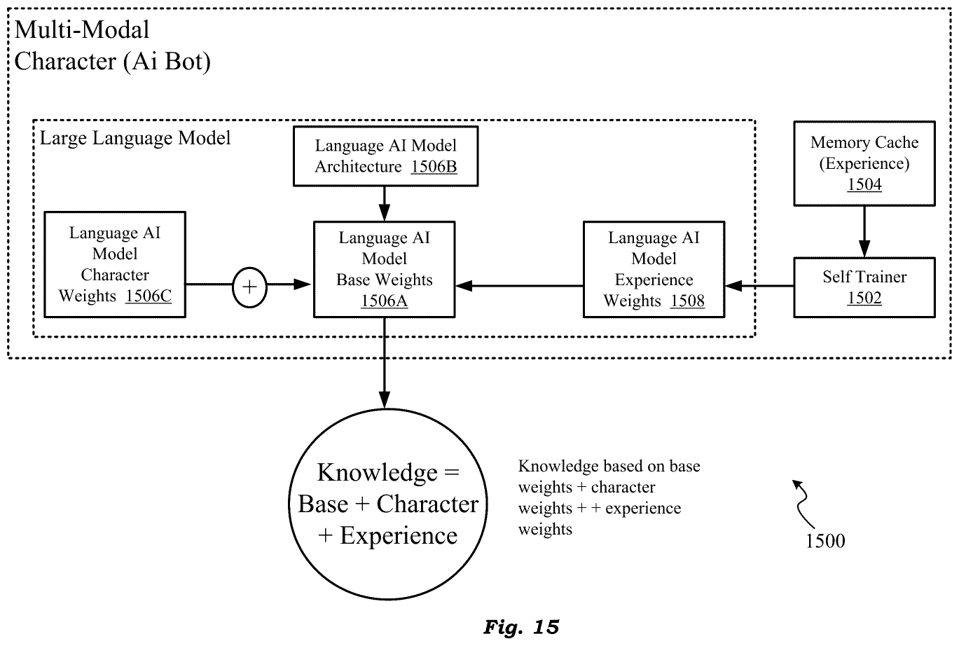

During non-peak environment input periods, such as at night or during a lull in sensory inputs, the chatbot fine-tunes its experience weights, which are preferably LoRA experience weights, by using the contents of the experience memory cache. FIG. 15 represents a composite diagram 1500 showing the various elements as well as the necessary steps required to implement this aspect of the present design.

As shown by process boxes marked by respective reference numerals in FIG. 15, when fine-tuning the experience weights, the following steps occur:
1502: The Self Trainer is responsible for training the Language AI Model experience weights.
1504: The current experience memory cache contents are used to train the experience weights much in the same way other weights (e.g. LoRA weights) are fine-tuned (see Brown 4, Karthik, and Sridykhan. Since the experiences within the experience memory cache are those of the chatbot itself, all experiences are used to fine-tune the experience weights.
1506A-C: During the fine-tuning process, the Language AI Model base weights, and all other Language AI Model secondary weights (e.g., character weights or performance weights) are frozen.
1508: Only the specific experience weights are fine-tuned.

Upon the completion of training, the experience memory cache is emptied and made ready for more environmental interactions or experiences. Note, training may occur during interaction downtimes, such as overnight, or even during interactive sessions in an adaptive manner in the background.

### Environmental Interactions After Fine-Tuning:

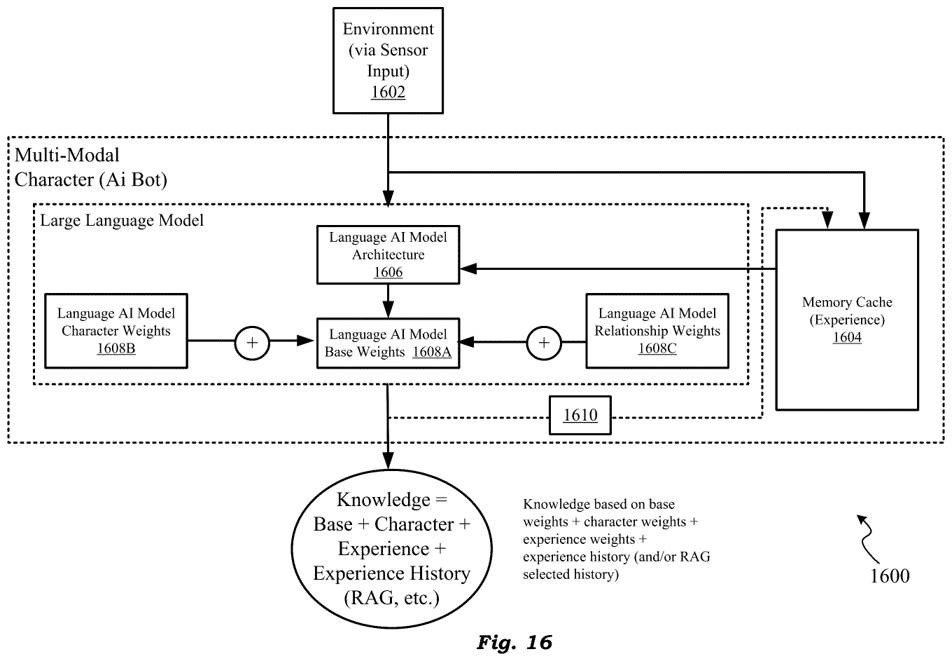

When an environmental interaction session occurs, after fine-tuning the experience weights, the fine-tuned weights are used in each future interaction during inference. FIG. 16 represents a composite diagram 1600 showing the various elements as well as the necessary steps required to implement this aspect of the present design.

As shown by process boxes marked by respective reference numerals in FIG. 16, the following steps occur when the chatbot has environmental interactions and experiences after fine-tuning the experience weights and clearing the experience memory cache.
1602: Like before, the environmental inputs from sensors, video, audio, image, or other types of inputs are sent to the chatbot and either pre-converted to text, then token then embedding or the chatbot is directly sent tokens that are then converted to embeddings, or the chatbot is directly sent the embeddings themselves.
1604: Optionally, text, embedding or raw input data stored within the experience memory cache (that are new since last fine-tuning) are also sent to the Language AI Model for processing. These are also converted into embeddings and processed with the inputs from the above step.
1606: If not already in embedding form, the Language AI Model first converts the inputs into embeddings.
1608A-C: Internally, the Language AI Model uses both the Language AI Model base weights along with the character weights and the newly fine-tuned experience weights to process the outputs to the new experiences from the environment which may be in the form of new chatbot thoughts, interpretations, and musings on the experiences from the environment.
1610: The interpretations, musings or otherwise thoughts of the chatbot based on its environmental experiences are then stored back in the experience memory cache and optionally output to the user.

### Combined Chat-Bot User and Environment Interactions:

As video, audio, image, and other sensor inputs become more integrated into the chatbot, user/chatbot interactions will often be combined with other environmental inputs that give the chatbot better situational awareness and overall context of the user interactions taking place.

User and environmental inputs are separated using special tokens like the BOS (beginning of sentence) and EOS (end of sentence) used today by Large Language Models. Current instruct-type models use the ‘INST’ token to signify the start of a prompt and the ‘\INST’ token to signify the end of the prompt. System prompts are similarly separated using the ‘SYS’ and ‘\SYS’ tokens. Environmental and other sensory input data can be separated in an equivalent manner. For example, an input stream may look like the following:

[INST]Tell me about your day. [\INST][ENV]Sunny outside, warm, light wind, spring conditions, green, beautiful, geo-location: x,y, general location: Pacific Northwest[\ENV]

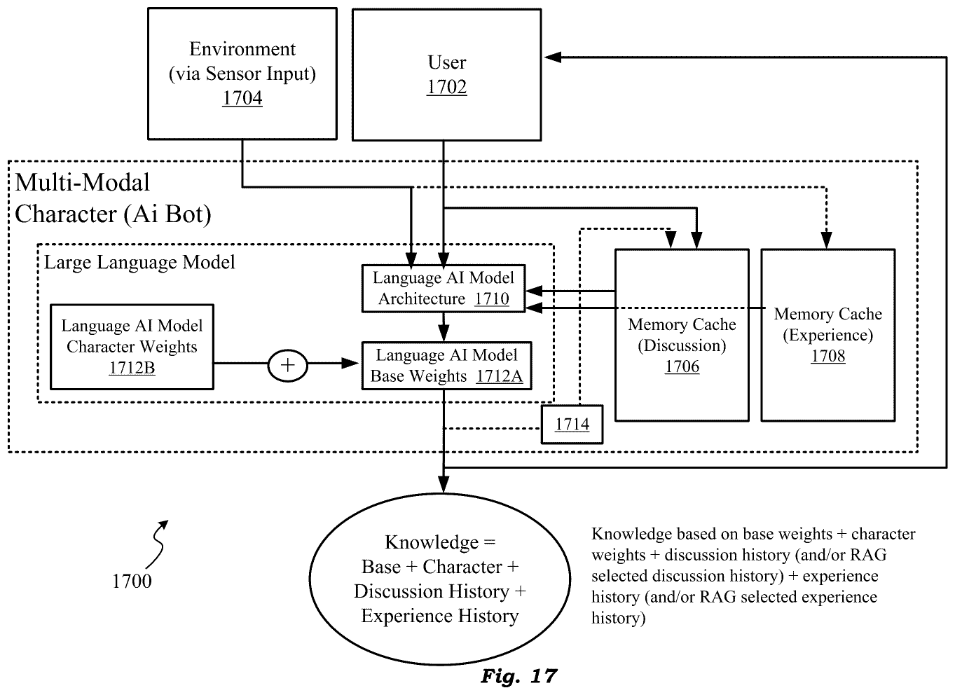

This input gives the chatbot more situational awareness about the chatbot's location where the sensor data describes the chatbot's surroundings, location, temperature, season, etc., thus allowing the chatbot to give a more informed answer to the question in the prompt. FIG. 17 represents a composite diagram 1700 showing the various elements as well as the necessary steps required to implement this aspect of the present design.

As shown by process boxes marked by respective reference numerals in FIG. 17, the following steps occur when interacting with the chatbot that is also receiving environmental inputs.
1702: The user directly sends prompts in text form to the chatbot. Alternatively, text (or direct embeddings) from one of the various input AI models (e.g., video to text, image to text, sensory data to text, etc.) are input to the chatbot. Note, such multi-modal inputs may be input simultaneously by separating each using special tokens like the use of the BOS (beginning of sentence) and EOS (end of sentence) special tokens that are currently used by large language models to designate input blocks. The inputs are sent to the Large Language Model while simultaneously being sent to the discussion memory cache for later processing.
1704: At the same time, the environmental inputs from sensors, video, audio, image, or other types of inputs are sent to the chatbot and either pre-converted to text, then token then embedding or the chatbot is directly sent tokens that are then converted to embeddings, or the chatbot is directly sent the embeddings themselves. The inputs are sent to the Large Language Model while simultaneously being sent to the experience memory cache for later processing.
1706: The Language AI Model also receives inputs from the discussion memory cache for user discussion context.
1708: The Language AI Model also receives inputs from the experience memory cache for environmental context.
1710: The Language AI Model receives the inputs, optionally separated by source using special tokens and converts all inputs into embeddings (if necessary) and runs the data through the inferencing.
1712A-B: During inferencing the Language AI Model base weights are used in combination with the character weights to produce the output tokens.
1714: The output tokens are de-tokenized and sent to the Rendering Device which then interacts with the user. Simultaneously the output tokens are either directly stored in the discussion memory cache and optionally experience memory cache (for environmental related thoughts) as tokens or as de-tokenized text.

### Combined Relationship and Experience Training:

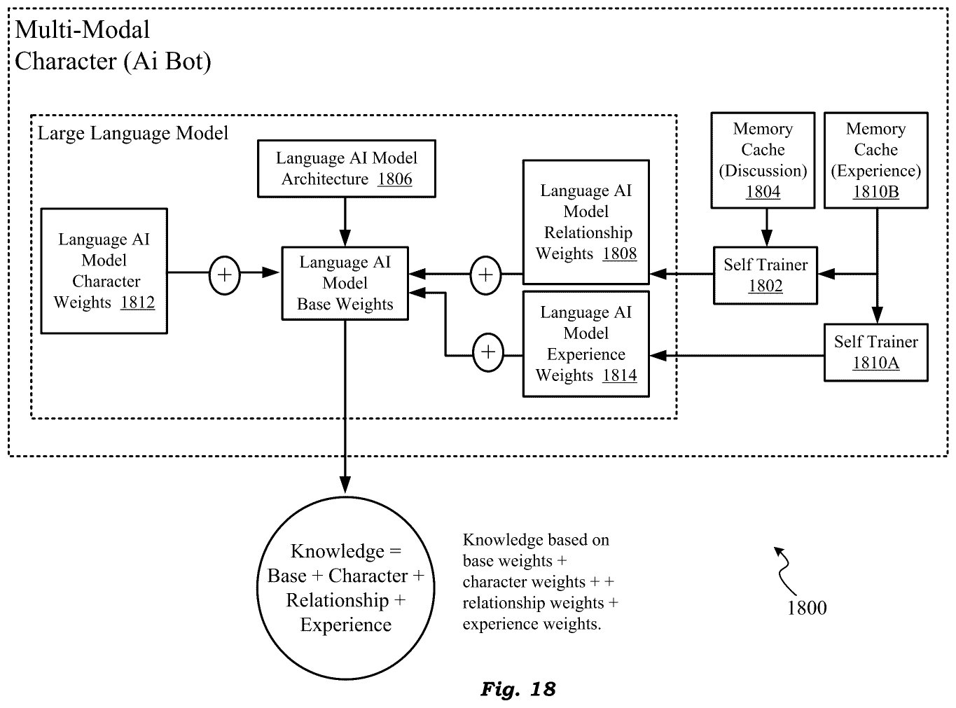

During interaction or sensory input downtimes, the chatbot self-trains on the Discussion and experience memory cache' data. During fine-tuning a specific user's interactions within the discussion memory cache are used to fine-tune the relationship weights assigned to that user. In addition, the environmental inputs are also used to fine-tune the experience weights and optionally fed as input into the relationship weight fine-tuning. Doing both allows for learning environmental experiences that occur during the user interaction. FIG. 18 represents a composite diagram 1800 showing the various elements as well as the necessary steps required to implement this aspect of the present design.

As shown by process boxes marked by respective reference numerals in FIG. 18, the following steps occur when fine-tuning both the relationship and experience weights.
1802: The Self Trainer is responsible for training the Language AI Model relationship weights.
1804: The current discussion memory cache contents, stored on a per user bases, are used to train the relationship weights much in the same way other secondary weights (e.g. LoRA weights) are fine-tuned (see Brown 4, Karthik and Sridykhan). However, during the fine-tuning, only the discussion memory cache items for a specific user are used to fine-tune secondary weights also assigned just to that user thus protecting the privacy of those discussions between the chatbot and the user. If, for example, the chatbot had discussions with multiple users between training sessions, specific LoRA weights are fine-tuned for each separate discussion using separate training sessions that fine-tune separate and distinct LoRA weights assigned to each user. In addition, the experiences occurring during the user discussion items are also fed into the fine-tuning of the Language AI relationship weights. Once training is completed the Discussion items for the specific user are removed from the discussion memory cache.
1806: During the fine-tuning process, the Language AI Model base weights, and all other Language AI Model weights (e.g., character weights, experience weights) are frozen.
1808; and only the specific relationship weights assigned to the user are fine-tuned.
1810A-B: Either the same Self Trainer or a secondary then fine-tunes the experience weights using the contents of the experience memory cache. Once training is completed, the experience memory cache is emptied.
1812: During training, all other weights of Language AI model are frozen.
1814: This allows for the experience weights to be fine-tuned specifically.

### Combined Chat-Bot User and Environment to Interactions After Fine-Tuning:

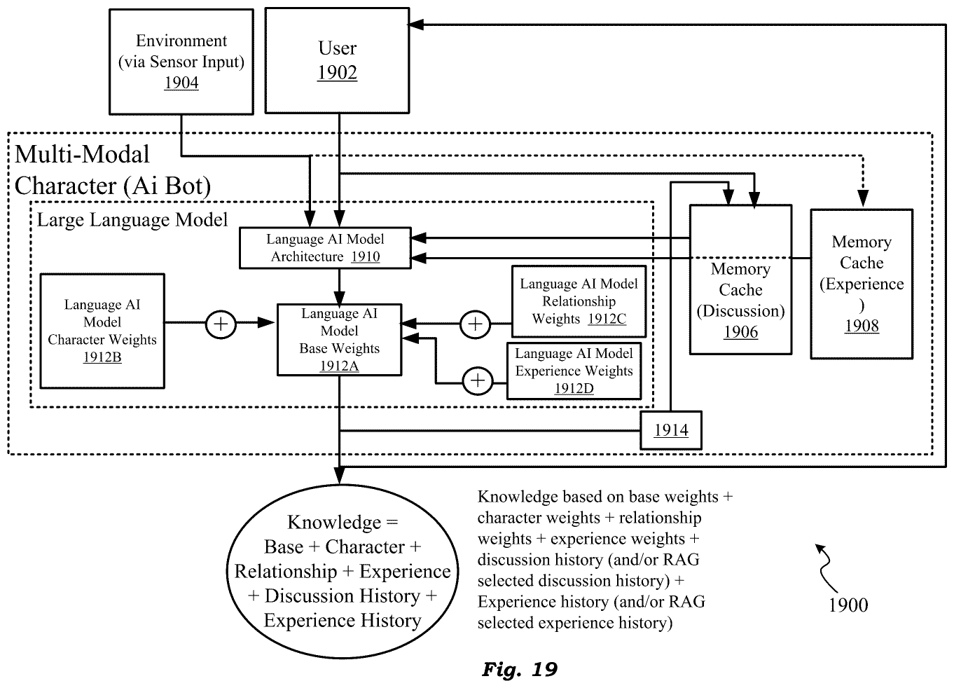

After fine-tuning the chatbot's relationship weights and environment weights, which are preferably LoRA environment weights, new user interactions consider the new knowledge learned by the chatbot. FIG. 19 represents a composite diagram 1900 showing the various elements as well as the necessary steps required to implement this aspect of the present design.

As shown by process boxes marked by respective reference numerals in FIG. 19, the following steps occur when interacting with the chatbot after its relationship and environment weights have been fine-tuned.
1902: The user directly sends prompts in text form to the chatbot. Alternatively, text (or direct embeddings) from one of the various input AI models (e.g., video to text, image to text, sensory data to text, etc.) are input to the chatbot. Note, such multi-modal inputs may be input simultaneously by separating each using special tokens like the use of the BOS (beginning of sentence) and EOS (end of sentence) special tokens that are currently used by large language models to designate input blocks. The inputs are sent to the Large Language Model while simultaneously being sent to the discussion memory cache for later processing.
1904: At the same time, environmental inputs such as sensor data, video, audio, and images are sent to the chatbot. These inputs are either pre-converted into text, then tokens, and finally embeddings, or they are directly sent as tokens which are then converted into embeddings. Alternatively, the chatbot may receive the embeddings directly. These inputs are simultaneously sent to the Large Language Model and the experience memory cache for later processing.
1906: The Language AI Model also receives inputs from the discussion memory cache for user discussion context.
1908: The Language AI Model also receives inputs from the experience memory cache for environmental context.
1910: The Language AI Model receives the inputs, optionally separated by source using special tokens and converts all inputs into embeddings (if necessary) and runs the data through the inferencing.
1912A-D: During inferencing the Language AI Model base weights are used in combination with the character weights, the Language AI Model relationship weights (associated with the user) and the environment weights to produce the output tokens.
1914: The output tokens are de-tokenized and sent to the user. Simultaneously the output tokens are either directly stored in the discussion memory cache and optionally experience memory cache (for environmental related thoughts) as tokens or as de-tokenized text.

### AI-Powered Character Avatars Across Multiple Domains Overview:

AI-driven characters are being developed for a wide variety of applications beyond traditional film and television roles. From scientific research and philosophical debates to health coaching, legal analysis, education, and speculative future modeling, these AI characters must be contextually aware, deeply knowledgeable, and continuously adaptable.

The ability to create highly specialized AI personalities requires a combination of fine-tuning approaches that ensure consistency, accuracy, and dynamic responsiveness across multiple interactions. The primary methodologies include:
Retrieval-Augmented Generation (RAG) for real-time contextualization
Fine-tuning with Low-Rank Adaptation (LoRA), Reinforcement Learning with Human Feedback (RLHF), Reinforcement Learning Without Human Feedback (RLHF-Free RL), and full model fine-tuning
Dynamic prompt engineering leveraging long context windows for real-time adaptation

These techniques allow AI-driven characters to be immersive, adaptive, and effective across legal analysis, educational tools, interactive debates, storytelling, scientific collaboration, and health coaching.

### Ramifications and Scope: Character Tuning Methodologies

### The Spectrum of Character Fine-Tuning Approaches:

Developing AI characters across such diverse applications necessitates a broad and flexible tuning strategy. While LoRA is widely used due to its efficiency, it must be complemented with other methodologies like RLHF, RLHF-Free RL, full model fine-tuning, and long-context adaptation to optimize AI behaviors and decision-making.

### 1. Low-Rank Adaptation (LoRA) as a Modular Fine-Tuning Tool

LoRA fine-tuning enables AI models to specialize in specific domains or character traits without needing full retraining. It provides:
Efficient personality adaptation for highly specific dialogue styles.
Scalability for multiple characters using modular LoRA tuning layers.
Computational efficiency, making it suitable for real-time character switching.

While LoRA allows rapid iteration and flexibility, it benefits from additional reinforcement mechanisms to enhance adaptability and responsiveness.

2. Reinforcement Learning with Human Feedback (RLHF) for Adaptive Intelligence

RLHF refines AI character responses by integrating human-provided feedback loops that reward accuracy and realism. This technique ensures:
Better alignment with human expectations and reasoning.
Iterative improvement, allowing AI characters to evolve over time.
A more dynamic, conversational style, particularly useful in long-term interactions.

When combined with LoRA, RLHF provides a powerful mechanism for maintaining consistent, engaging, and contextually relevant characters across different use cases.

### 3. Reinforcement Learning Without Human Feedback (RLHF-Free RL) and AI-Driven Reinforcement Learning

Using Group Relative Policy Optimization (GRPO) as implemented in DeepSeek-V3, AI models can refine their outputs without relying on human feedback. Additionally, reinforcement learning can be conducted using feedback from other LLMs (Large Language Models) rather than human evaluators. This model-to-model reinforcement process allows AI agents to critique, refine, and optimize their own outputs based on predefined reward criteria. This method works by:
Generating multiple possible responses for a given prompt.
Using a self-rewarding system that evaluates responses based on internal scoring rather than human labels.
Reducing human dependency, making AI character fine-tuning scalable and cost-efficient.

This approach is especially useful for automated legal reasoning, scientific analysis, and gaming AI where human feedback is impractical or unavailable. Additionally, LLM-based reinforcement learning can help refine legal argumentation, debate strategies, and creative ideation by leveraging multiple AI perspectives to iteratively refine responses.

### 4. Full Model Fine-Tuning for Deep Contextual Knowledge

Unlike LoRA, full model fine-tuning rewrites entire neural network layers, ensuring a deeper integration of knowledge. This method is best suited for:
Historical and scientific characters requiring domain expertise.
AI educators, legal experts, and tutors needing comprehensive knowledge synthesis.
Characters engaging in theoretical discussions or problem-solving across disciplines.

Full fine-tuning, while computationally intensive, creates more deeply embedded knowledge structures and allows AI characters to engage in complex discussions across multiple interactions.

### 5. Dynamic Prompt Engineering & Long Context Windows for Real-Time Adaptation

AI characters must retain continuity in interactions, particularly for legal mediation, health coaching, education, case law analysis, and evolving debates. Long-context prompting and dynamic engineering enable:
Integration with subject profile data, allowing characters to adapt based on user history, expertise level, and ongoing case details.
Real-time memory of past conversations, improving engagement.
Adjustable behavior based on user interaction history for continuity in decision-making.
Multi-session continuity, allowing characters to develop relationships with users over time.

This approach is critical for AI legal analysts, mentors, debate-driven characters, and role-playing applications that require persistent context awareness without modifying model weights.

### 6. Combining Fine-Tuning Methods for Optimal Performance

Each method plays a distinct role in character training, and their combination is essential for maximizing AI potential across applications:

| | Customization | Computational | |
|---|---|---|---|
| Method | Depth | Cost | Best For |
| LoRA | Medium | Low | Scalable personality |
| | | | adaptation, modular |
| | | | updates |
| RLHF | High | Medium | Adaptive learning, |
| | | | dynamic conversations |
| RLHF-Free RL | High | Medium | Self-rewarding AI |
| (GRPO) | | | refinement, |
| | | | autonomous agents |
| Full Model | Very High | High | Deep expertise, |
| Fine-Tuning | | | theoretical synthesis |
| Dynamic | Low | Very Low | Context-aware, |
| Prompting | | | real-time |
| | | | responsiveness |

### Conclusion—Comprehensive AI Character Training for Diverse Applications:

As AI-driven characters continue to expand across diverse applications, selecting the right combination of fine-tuning methodologies is crucial. Different domains require varying levels of depth, adaptability, and responsiveness, and the interplay between LoRA, RLHF, RLHF-Free RL, full model fine-tuning, and dynamic prompt engineering ensures characters remain effective across different contexts.

For applications such as philosophical debate (BotMuseum.ai), medical diagnostics (DifferentialDx.ai), immersive role-playing (StarCaster), health coaching (Energize.me), scientific discourse (RadicalScience.ai), speculative future modeling (FutureVibe.ai), media-driven storytelling (ReelTalk), biographical preservation (Jivana), and legal analysis (CaseAtlas), an adaptable tuning framework is essential.

By leveraging the strengths of multiple fine-tuning approaches, AI characters can be designed to be deeply knowledgeable, dynamically responsive, and continuously evolving, enabling them to serve as powerful tools for learning, discovery, and decision-making across a broad range of use cases.

### Jivana: Legacy Character Bots

### Overview:

Jivana is an advanced application of the character engine designed to create AI-powered digital or physical avatars that preserve and replicate a user's personality, knowledge, and experiences for future generations. The name “Jivana,” derived from Hindi, meaning “life,” encapsulates the mission of ensuring digital immortality through AI-driven biographical and conversational modeling.

This is achieved by conducting extensive interviews with helper chatbots, processing user-uploaded documents, and integrating third-party contributions. The resulting character profile serves two main purposes:
1. Generating a detailed biography of the character
2. Training a chatbot clone that embodies the character's knowledge, personality, and conversational style

Unlike simple Retrieval-Augmented Generation (RAG), which only regurgitates stored embeddings, this approach fine-tunes the model itself using Low-Rank Adaptation (LoRA), Reinforcement Learning with Human Feedback (RLHF), and alternative fine-tuning methodologies, enabling a deeply integrated and highly authentic representation of the character while maintaining access to the general world knowledge of the LLM.

The resulting digital legacy character can be embodied in:
Digital form using character animation engines such as HeyGen, D-ID, or Tavus
Physical form via robotic avatars capable of lifelike interactions

### System Components and Workflow:

### 1. Data Collection and Character Profile Creation

User Interaction with Helper Chatbots
The user engages in structured conversations with AI-powered interview chatbots designed to extract detailed biographical information.
The interview process is multi-stage, covering:
   Childhood and Early Life
   Education and Professional Achievements
   Personal Values and Philosophies
   Memorable Life Events and Stories
   Hobbies, Interests, and Favorite Topics
   Speech Patterns, Mannerisms, and Unique Expressions
AI-guided follow-up questions ensure a thorough and accurate representation of the character.

### Document and Media Upload

Users can upload various personal documents, including:
   Books, papers, and articles authored by the individual
   Diaries, letters, and personal notes
   Photos, audio recordings, and video clips
   Transcripts from interviews, speeches, or conversations
   Memories contributed by friends, family, or third-party collaborators

### Third-Party Contributions

Family members, colleagues, and friends can be invited to contribute stories, questions, and missing details to help create a more complete character profile.
AI-generated prompts assist contributors in recalling and providing relevant anecdotes and insights.

### 2. Character Profile Structuring and Fine-Tuning

### Data Processing and RAG Embedding

All collected textual data undergoes Retrieval-Augmented Generation (RAG) processing, converting the information into vector embeddings for efficient retrieval.
Metadata tagging ensures quick access to specific life events, concepts, or personality traits.
   Fine-Tuning with LoRA, RLHF, and Alternative Methods:

Jivana employs multiple fine-tuning approaches to ensure the chatbot clone accurately embodies the original character while retaining access to general world knowledge. These methods include:
1. Low-Rank Adaptation (LoRA):
   Character-specific data is used to generate lightweight LoRA weights that refine the model's behavior while preserving the broader linguistic and factual knowledge of the LLM.
   This method allows efficient adaptation without full retraining.
2. Reinforcement Learning with Human Feedback (RLHF):
   Users and contributors rate chatbot responses for accuracy, relevance, and personality fidelity.
   The model is trained using a reward model that prioritizes highly rated responses.
   RLHF fine-tunes conversational nuances such as humor, emotional tone, and engagement.
3. Full Model Fine-Tuning:
   In select cases, where extensive customization is required, full model fine-tuning is performed to deeply integrate character-specific traits.
   This involves retraining on the entire biographical dataset, ensuring high fidelity but at a higher computational cost.
4. Dynamic Prompt Engineering with Long Context Windows:
   Instead of permanent fine-tuning, long-context LLMs dynamically adjust responses using structured prompts.
   The model retrieves relevant biographical memories using an optimized embedding retrieval system, effectively simulating fine-tuning in real-time.
   This approach enables memory updates without model retraining, offering flexibility for evolving character knowledge.

### 3. Multi-Modal Avatar Generation

Once the character's chatbot is fine-tuned, it can be deployed in various embodiments:

### Digital Embodiment (2D & 3D Animated Characters)

The chatbot clone is integrated with character animation engines such as:
   HeyGen: AI-generated avatars with expressive animation
   D-ID: Realistic talking head animations
   Tavus: AI-generated video content with dynamic expressions
The AI uses Text-to-Speech (TTS) models trained on the user's voice (if available) for greater authenticity.
Lip-syncing models ensure realistic mouth movements in alignment with speech.

### Physical Embodiment (Robotic Avatars)

The chatbot can be installed into humanoid robotic platforms with:
   Lifelike facial animations and body gestures
   Real-time voice synthesis
   Multi-modal sensory interpretation (vision, touch, audio input, etc.)
Example Robotic Platforms:
   Engineered Arts' Ameca (humanlike robotic assistant)
   Boston Dynamics' Spot (if adapted for storytelling/interaction)
   Custom-built robotics with embedded AI brains

### 4. Continuous Learning and Personalization

The chatbot continues adapting over time based on interactions with users.
New memories and feedback are stored using stacked LoRA weights, ensuring:
   Original character integrity is preserved
   User-specific refinements are added without altering the core persona
The chatbot periodically undergoes additional fine-tuning or dynamic prompt engineering to incorporate new insights or updates provided by authorized contributors.

### Conclusion:

Jivana represents a groundbreaking application of character technology, offering digital immortality through advanced AI-driven biographical modeling. By leveraging LoRA fine-tuning, RLHF, full model fine-tuning, and dynamic prompt engineering, Jivana enables highly realistic, interactive, and ever-evolving character bots that extend far beyond simple content retrieval. Whether deployed as a digital avatar or a physical robotic entity, Jivana ensures that personal legacies can be preserved and shared across generations.

### ReelTalk: AI-Powered Character Avatars for Film, Television, Media, and Advertising

### Overview:

ReelTalk is an advanced AI-powered platform designed to create lifelike, interactive character avatars for film, television, media, and advertising. By integrating multimodal AI technologies, ReelTalk enables digital and physical embodiments of fictional characters, historical personas, and brand mascots. These AI avatars retain knowledge of their source material while interacting dynamically with users in an immersive, intelligent, and contextually relevant manner.

ReelTalk's core functionality is powered by a combination of:
Retrieval-Augmented Generation (RAG) for real-time contextualization
Fine-tuning with Low-Rank Adaptation (LoRA), Reinforcement Learning with Human Feedback (RLHF), and full model fine-tuning
Dynamic prompt engineering leveraging long context windows for real-time adaptation

These capabilities allow ReelTalk to power AI-driven characters that understand, respond, and evolve within interactive digital environments, promotional campaigns, and live media engagements.

### System Components and Workflow:

### 1. Input Data Sources for Character Training

ReelTalk aggregates extensive source material to build a comprehensive character knowledge base. The following input data sources feed into the AI training pipeline:

### Primary Narrative Materials

Film & Television Scripts: The screenplay serves as the foundation for character behavior, speech patterns, and narrative arcs.
Underlying Source Material: Books, plays, graphic novels, or historical records that inspired the screenplay.
Continuity & Scene Descriptions: Production notes, storyboard annotations, and director's notes that provide context for character motivations.

### Character-Related Content

Transcripts of Character Interviews: Actor portrayals, interviews, behind-the-scenes commentary.
Extended Universe Materials: Companion novels, spin-off content, fan theories, and lore expansions.
Dialogue Samples & Catchphrases: Signature phrases, dialects, and idiosyncratic speech patterns.

### Branding & Marketing Data

Brand Guidelines for IP-Based Characters: Ensures consistency in tone, messaging, and visual fidelity for corporate and commercial characters.
Advertising & Promotional Content: Commercial scripts, social media interactions, and past marketing campaigns.
Licensing Restrictions & Persona Constraints: Legal frameworks governing character use and adaptation.

### Performance-Based AI Training

Facial & Motion Capture Data: Used for digital avatars and deep-learning-based animation synthesis.
Voice Samples & Speech Data: TTS models trained on original actor performances or authorized recreations.
Scene-Specific Emotional Context: Behavioral cues extracted from scene emotion tagging.

All of these inputs are processed through AI pipelines that convert text, audio, and visual data into structured training sets for character modeling.

### 2. Fine-Tuning Strategies for Character Accuracy

ReelTalk employs multiple AI fine-tuning strategies to ensure characters accurately mimic their source material while remaining interactive.

### 1. Low-Rank Adaptation (LoRA) Fine-Tuning

LoRA optimizes pre-trained large language models by training lightweight task-specific layers.
Applied for quick adaptation to specific character tones, knowledge domains, and dialogue styles.
Example: A Marvel superhero can be fine-tuned using canonical dialogues and interactions without modifying the full model.
   2. Reinforcement Learning with Human Feedback (RLHF)
RLHF is used for refining character engagement, humor, and tone consistency.
Human testers rate generated responses, reinforcing desirable conversational traits.
Example: A late-night talk show host AI might be trained to generate responses that align with witty, audience-friendly banter.

### 3. Full Model Fine-Tuning

For high-fidelity AI personas, full model retraining is conducted on the entire character dataset.
Ideal for characters requiring deep expertise or expanded contextual awareness.
Example: A chatbot embodying Sherlock Holmes might be fine-tuned on the full literary corpus, past films, and historical detective methods.
   4. Dynamic Prompt Engineering with Long Context Windows
Instead of static fine-tuning, ReelTalk supports real-time adaptation via long-context LLMs.
Structured prompt engineering allows character AIs to “remember” past interactions while dynamically retrieving context-relevant information.
Example: A sci-fi character interacting in an evolving game narrative retrieves in-universe lore dynamically rather than relying solely on pre-trained weights.

By combining these fine-tuning methodologies, ReelTalk enables AI personas that are authentic, adaptive, and engaging.

### 3. Multi-Modal Avatar Deployment

Once trained, characters are deployed across various interactive and media-driven applications.

### Digital AI Avatars for Interactive Media

Real-Time AI Chatbots: AI-powered social media engagement, virtual influencers, and fan interactions.
Live Event Hosts & Narrators: Characters appear in AI-generated press events, interviews, and scripted performances.
Conversational Film & TV Companions: Viewers engage with AI film companions that provide behind-the-scenes insights.

### AI-Powered Advertising Characters

Brand Mascots & Spokespersons: Fully interactive versions of existing brand ambassadors and iconic media figures.
AI-Driven Product Placement: Adaptive virtual personalities assist in promoting branded merchandise in interactive digital spaces.
Commercial AI Voice Assistants: Intelligent voice interactions tailored to brand-specific messaging.

### Physical AI-Integrated Characters

Robotic Character Embodiments: AI personas installed in humanoid robots for live interactive performances.
Theme Park & Entertainment Animatronics: Character AIs sync with physical animatronic rigs for immersive storytelling.
Retail & Concierge AI Systems: AI-powered kiosks, assistants, and store mascots capable of interactive product recommendations.

### 4. Real-Time Memory, Adaptation, and Evolution

AI characters retain context across conversations via long-term memory embeddings.
Adaptive learning cycles allow them to evolve based on audience interactions and live engagements.
Continuous updates ensure characters stay relevant even as new content is released (e.g., TV series renewals, film sequels).

### Conclusion:

ReelTalk represents a new frontier in AI-driven character interaction, enabling film, TV, and advertising industries to leverage AI personas that can authentically replicate and extend fictional characters beyond traditional media. By combining multimodal AI training, advanced fine-tuning strategies, and real-time adaptation techniques, ReelTalk offers unprecedented character immersion, blurring the line between fiction and interactive reality.

### StarCaster: AI-Powered Actor Training for Film, Television, Media, and Advertising

### Overview:

StarCaster is an advanced AI-driven platform designed to revolutionize actor training, audition preparation, and role-matching for film, television, media, and advertising. By leveraging cutting-edge AI models, StarCaster provides actors with interactive, context-aware character simulations to rehearse and refine their performances.

Actors can train for specific roles by interacting with AI-driven characters that embody the speech, emotions, and behaviors of their counterparts in a scene. The platform also evaluates the actor's performance, providing real-time feedback on delivery, emotional expression, and consistency.

StarCaster serves multiple use cases:
1. Replacement or addition to casting platforms like Actors Access and BackStage, where actors can practice and apply for roles.
2. Audition Preparation & Role Rehearsal, allowing actors to refine performances with an AI counterpart before live rehearsals.
3. Acting Education & Training, providing an invaluable AI-powered learning assistant for aspiring and professional actors.
4. Actor Profiling & Role Matching, using AI-driven assessments to suggest ideal roles based on an actor's skills, experience, and artistic preferences.

By integrating LoRA fine-tuning, RLHF (Reinforcement Learning with Human Feedback), and long-context prompt engineering, StarCaster ensures authentic, adaptive, and personalized AI character training for actors.

### System Components and Workflow:

### 1. Input Data Sources for Character Training

To create highly realistic AI-powered acting partners, StarCaster integrates extensive source materials to train character AI models.

### Primary Narrative & Performance Data

Scripts & Screenplays: Full-text scripts for film, television, and stage performances.
Underlying Source Material: Novels, plays, and historical records from which the script was adapted.
Stage & Scene Descriptions: Director's notes, production continuity sheets, and staging diagrams.
Character Notes & Performance Instructions: Annotations from scriptwriters, acting coaches, and dramaturgs.

### Performance & Speech Modeling Data

Actor-Delivered Performance Data: Archived stage and film performances for voice, timing, and intonation modeling.
Dialogue & Accent Training Data: Actor-specific phonetic data, speech analysis, and regional accent information.
Character Movement & Expression Data: Motion capture, facial expression datasets, and gestural cues.

### Contextual & Background Knowledge

Historical & Cultural Background: Insights into the time period, societal norms, and cultural influences relevant to the character.
Character Relationships & Psychological Profiles: AI understanding of relationships between characters, including emotional arcs and interactions.

### 2. AI Character Fine-Tuning Strategies

StarCaster employs multiple fine-tuning techniques to create authentic and context-aware character simulations:

### 1. Low-Rank Adaptation (LoRA) Fine-Tuning

Efficient model adaptation to train specific character traits without retraining the entire language model.
Allows rapid deployment of character-specific AI models, ensuring Juliet speaks in the Shakespearean tone and rhythm when rehearsing with an actor playing Romeo.
   2. Reinforcement Learning with Human Feedback (RLHF)
AI character responses are iteratively refined based on user feedback.
Helps improve AI character consistency, emotional depth, and improvisation skills.
Used to train AI evaluators that assess an actor's performance based on expert-rated feedback.

### 3. Full Model Fine-Tuning

Required for AI characters that need deep, multi-scene knowledge and emotional evolution.
Example: Training a Hamlet AI that responds differently depending on which act and scene the actor selects.

### 4. Dynamic Prompt Engineering & Long Context Windows

Enables scene-based real-time adaptation without modifying base AI model weights.
Actors select acts and scenes, and the AI dynamically retrieves contextually relevant information.
Long-context prompt retrieval ensures actors can rehearse extended sequences with memory consistency.

### 3. User Profiling & Role Matching

To enhance role compatibility, StarCaster builds detailed actor profiles using AI-driven assessments:

### Actor Performance Data & AI Profiling

Voice & Speech Analysis: AI evaluates vocal range, intonation, and delivery style.
Emotional Expression Tracking: AI recognizes facial expressions and body language.
Scene Performance Ratings: AI-generated scores based on timing, emotional intensity, and accuracy.
Improvisation & Adaptability Metrics: AI assesses how well an actor can react to unexpected scene changes.

### Role Matching AI System

AI Recommender System suggests roles based on actor performance metrics and casting requirements.
Comparison with Existing Talent Pool: AI compares an actor's profile against historical casting data.
Personalized Recommendations: AI identifies potential roles aligned with an actor's strengths and artistic goals.

### 4. Interactive Actor Training & Evaluation

### Real-Time AI Character Interaction

Actors engage in AI-driven scene rehearsals with highly trained digital characters.
Scene Customization Options:
   Select act, scene, and emotion settings.
   Choose Shakespearean vs. modern English (for classical roles).
   Adjust difficulty level to make AI responses more challenging for advanced training.

AI Performance Evaluation & Feedback
Dialogue Timing Assessment: AI evaluates pacing, rhythm, and responsiveness.
Emotional Consistency: AI detects authentic emotional delivery vs. mechanical recitation.
Voice Modulation Feedback: AI suggests changes in volume, pitch, and emphasis.
Adaptive Learning: AI tracks actor progress and adjusts difficulty for skill improvement.

### 5. Deployment & Applications

StarCaster is designed for actors, casting professionals, and educators.

### For Individual Actors

Audition Prep & Role Familiarization: Actors rehearse scripted scenes before live auditions.
Private Acting Coaching: AI characters provide personalized feedback and guidance.
Monologue Practice: AI evaluates solo performances and refines voice, tone, and pacing.

### For Casting Platforms & Studios

AI-Enhanced Auditions: Casting directors can assess actors based on real-time AI scene performances.
Remote Role Tryouts: Actors worldwide can audition through AI-simulated casting calls.

### For Acting Schools & Educators

Interactive Acting Curriculum: AI-based scene practice, feedback, and assessments.
Scene Study with AI Partners: Students rehearse Shakespeare, film scripts, or improv scenes with responsive AI characters.

### Conclusion:

StarCaster is a game-changing AI tool for actors, casting professionals, and acting educators. By integrating LoRA fine-tuning, RLHF training, full model optimization, and dynamic long-context AI prompts, it enables realistic, interactive, and evaluative character simulations. Whether preparing for auditions, rehearsing for roles, or refining acting skills, StarCaster provides unmatched AI-driven coaching and training, revolutionizing how actors prepare for the screen and stage.

### Energize.me: AI-Powered Health Coaching

### Overview:

Energize.me is an advanced AI-powered health coaching platform designed to provide personalized, interactive, and data-driven coaching experiences. The platform enables users to engage with highly trained AI health coaches, each representing a specific health philosophy, dietary regimen, or lifestyle approach. These AI coaches are trained on comprehensive corpora of scientific literature, clinical studies, and practitioner insights tailored to their particular health framework.

Energize.me integrates real-time user data from wearables, medical devices, and personal history to create an adaptive, personalized coaching experience. The platform fine-tunes AI models using LoRA, RLHF (Reinforcement Learning with Human Feedback), and long-context prompt engineering, allowing health coach characters to dynamically adjust recommendations based on a user's evolving health status.

### System Components and Workflow:

### 1. Input Data Sources for AI Health Coach Training

Each AI health coach is trained on a highly curated knowledge base corresponding to its health philosophy. The input sources include:

### Foundational Health & Wellness Knowledge

Medical Research & Clinical Studies: Peer-reviewed journals, meta-analyses, and systematic reviews.
Nutrition & Dietary Guidelines: Official recommendations from organizations like the WHO, CDC, and NIH.
Exercise Science & Movement Therapy: Strength training principles, rehabilitation strategies, and cardiovascular conditioning methodologies.
Behavioral Psychology & Habit Formation: Cognitive Behavioral Therapy (CBT), motivational interviewing, and neuroplasticity research.

### Health Coaching Perspectives & Specialized Frameworks

Each AI coach is trained to represent a particular school of thought in health and wellness. Examples include:
Keto & Low-Carb Coach: Trained on ketogenic diet research, metabolic adaptation, and insulin regulation.
Vegan & Plant-Based Coach: Grounded in whole-food plant-based nutrition, longevity studies, and environmental impact research.
Intermittent Fasting Coach: Educated on time-restricted eating, circadian rhythms, and autophagy science.
Functional Medicine Coach: Knowledgeable in holistic diagnostics, gut health, and root-cause medicine.
Longevity & Biohacking Coach: Focused on genetic optimization, caloric restriction, and supplement protocols.
Mind-Body Wellness Coach: Covers mindfulness, yoga, stress reduction, and mind-body synergy.

These AI coaches ensure that users receive consistent, evidence-based coaching tailored to their chosen health philosophy.

### 2. User Profiling & Personal Data Integration

Energize.me builds a highly personalized profile for each user, incorporating:

### User-Provided Information

Medical History & Health Conditions: Chronic illnesses, past injuries, genetic predispositions.
Dietary Preferences & Restrictions: Allergies, ethical dietary choices, macro/micronutrient goals.
Lifestyle & Activity Levels: Sedentary, moderately active, or highly active routines.
Health & Fitness Goals: Weight loss, muscle gain, stress reduction, disease prevention.
   Real-Time Data from Connected Health Devices

Energize.me ingests live health data from:
Wearable Devices (Apple Watch, Fitbit, WHOOP, Garmin, Oura Ring):
   Heart rate variability (HRV) a Resting heart rate (RHR)
   Steps and activity levels
   Sleep patterns & quality
   Blood oxygen saturation (SpO2)
   Skin temperature & stress levels
Continuous Glucose Monitors (CGMs) (Dexcom, FreeStyle Libre):
   Blood glucose trends & meal response tracking
Smart Scales & Body Composition Analyzers (Withings, Tanita, RENPHO):
   Body fat percentage
   Lean muscle mass
   Water retention levels
Smart Blood Pressure Monitors (Omron, Qardio):
   Hypertension risk assessments
Smart Thermometers & Biofeedback Devices (Kinsa, Muse):
   Body temperature for illness detection
   EEG-based stress & meditation insights By integrating multi-source data, AI health coaches gain a dynamic understanding of the user's health trends and can adapt coaching strategies accordingly.

### 3. AI Fine-Tuning Strategies for Personalized Coaching

Energize.me employs multiple AI fine-tuning methodologies to customize health coaching for each user.

### 1. Low-Rank Adaptation (LoRA) Fine-Tuning

LoRA enables AI models to efficiently specialize in a particular health philosophy without overwriting general medical knowledge.
Coaches are fine-tuned on user-specific health data, ensuring that recommendations evolve based on real-time biometric inputs.
Example: A keto-focused AI coach adapts fasting duration based on real-time blood glucose fluctuations.
   2. Reinforcement Learning with Human Feedback (RLHF)
RLHF refines AI health coach responses using feedback from human health experts and users.
AI receives reinforcement signals for:
   Accuracy of nutritional recommendations.
   Effectiveness of fitness programming.
   Emotional intelligence in user interactions.
Example: Users rate the usefulness of an AI-prescribed stress-reduction technique, improving future suggestions.

### 3. Full Model Fine-Tuning

For users with complex medical conditions, full fine-tuning is employed to provide more in-depth, condition-specific coaching.
Example: A user with Type 2 diabetes receives a fine-tuned AI coach optimized for blood sugar control strategies.

### 4. Dynamic Prompt Engineering & Long Context Windows

AI health coaches use long-context models to maintain continuous awareness of a user's health journey.
AI dynamically retrieves and processes historical biometric trends, avoiding static coaching advice.
Example: A user with a sleep disorder receives evolving guidance based on months of sleep tracking data rather than isolated recommendations.

### 4. Real-Time Interaction & Coaching Adaptation

### Interactive Health Coaching

Users engage in natural language conversations with AI coaches.
Real-time adaptation based on:
   Changes in biometric readings.
   Recent food intake and meal logs.
   New workout data and physical activity levels.
Example: After a poor night's sleep, AI coach modifies the day's exercise intensity and meal recommendations to optimize recovery.

### AI-Driven Goal Tracking & Feedback

AI tracks goal adherence and provides customized encouragement and corrective advice.
Users receive:
   Daily progress reports with AI-generated insights.
   Predictive analytics on long-term health outcomes.
   Automated nudges to keep habits consistent.

### 5. Deployment & Use Cases

### For Individual Users

Personalized Coaching & Optimization: AI-driven daily health guidance.
Goal-Oriented Training: Supports weight loss, muscle gain, longevity strategies.
Symptom & Risk Management: Helps detect early warning signs based on wearable data.

### For Health & Wellness Professionals

AI-Assisted Patient Monitoring: Health professionals receive AI summaries of client progress and health patterns.
Virtual Coaching Expansion: Coaches scale their reach using AI-augmented health consultations.

### For Corporate & Wellness Programs

Employee Wellness Initiatives: AI-driven fitness, nutrition, and mental well-being coaching.
Insurance & Preventive Care Applications: AI-powered risk assessment models for early disease prevention.

### Conclusion:

Energize.me redefines health coaching by integrating AI-driven expertise, real-time biometric insights, and personalized fine-tuning methodologies. By employing LoRA fine-tuning, RLHF training, full model optimization, and dynamic long-context AI prompts, Energize.me delivers a truly adaptive, data-driven health coaching experience, empowering users to optimize their wellness, fitness, and longevity goals in a way never before possible.

### DifferentialDx.ai: AI-Powered Medical Education & Differential Diagnosis Training

### Overview:

DifferentialDx.ai is an AI-driven medical education platform designed to train medical students and healthcare professionals in differential diagnosis. By simulating expert medical interactions, the platform enables users to present clinical histories, symptoms, and lab findings to AI-driven medical specialists, who then provide potential diagnoses and suggest follow-up tests.

The platform features multiple AI doctor characters, each representing a specific medical specialty, ensuring that learners receive specialized insights from different clinical perspectives:
Hippocrates (General AI Expert in All Fields)
Cardiology AI (Specialized in cardiovascular diseases)
Oncology AI (Specialized in cancer diagnosis & treatment)
Gastroenterology AI (Specialized in digestive disorders)
Psychiatry AI (Specialized in mental health & behavioral disorders)
General Practice AI (Primary care, broad internal medicine knowledge)

Each AI character is trained on a core medical knowledge base while being fine-tuned on specialty-specific knowledge, ensuring accurate, context-aware differential diagnosis recommendations.

Beyond medical education, DifferentialDx.ai has future applications in clinical decision support, helping physicians refine diagnoses and treatment plans as AI trust and capabilities improve.

### System Components and Workflow:

### 1. Training Data Sources for AI Medical Experts

To ensure highly accurate differential diagnosis reasoning, DifferentialDx.ai integrates multi-tiered data sources for training:

### General Medical Knowledge (for All AI Characters)

Medical Textbooks & Literature (Harrison's Principles of Internal Medicine, Cecil's Medicine, Davidson's)
Clinical Guidelines & Protocols (WHO, CDC, NIH, UpToDate, NICE, ESC, AHA, NCCN, APA)
Electronic Health Records (EHR) Case Studies (De-identified patient data)
Clinical Decision Support Systems (CDSS) Insights
Standard Diagnostic Criteria (ICD-10, DSM-5, SNOMED CT, AMAs CPT Codebase) Specialty-Specific Training (Fine-Tuning for Each AI Doctor)
Cardiology AI: Focused on ECG interpretation, heart failure, arrhythmias, myocardial infarctions, hypertension.
Oncology AI: Specialized in cancer staging, tumor markers, chemotherapy regimens, precision medicine.
Gastroenterology AI: Trained on GI tract disorders, endoscopy findings, gut microbiome, inflammatory bowel diseases.
Psychiatry AI: Developed with expertise in depression, schizophrenia, neuropsychological testing, cognitive therapy, psychopharmacology.
General Practice AI: Covers family medicine, internal medicine, pediatrics, preventive medicine, routine screenings.

Each AI medical expert maintains a general medical foundation but incorporates fine-tuned specialty knowledge to ensure domain-specific accuracy.

### 2. Interactive Clinical Case Simulation

### User Input: Presenting a Clinical Case

Medical students and professionals simulate a real-world consultation by presenting a patient case:
Chief Complaint (Example: “Patient presents with chest pain and shortness of breath.”)
History of Present Illness (HPI) (Detailed timeline, severity, associated symptoms)
Past Medical History (PMH) (Chronic diseases, surgeries, genetic predispositions)
Medications & Allergies
Social History (Smoking, alcohol, drug use, stress, occupational hazards)
Family History (Genetic risk factors, familial conditions)
Review of Systems (ROS) (Comprehensive symptom checklist)

### AI Doctor Response: Generating a Differential Diagnosis

Based on the provided clinical case details, the AI doctor generates:
1. Differential Diagnosis List (Ranked by probability and urgency)
2. Justification for Each Possible Diagnosis (Based on medical knowledge, patient data)
3. Recommended Next Steps:
   Diagnostic Tests & Labs (Blood tests, imaging, biopsies, genetic screening, psychiatric evaluations)
   Clinical Examination Suggestions (Physical maneuvers, mental status assessments, auscultation findings)
   Further History Questions (Clarifications to refine the diagnosis)

The AI models engage in iterative questioning, refining the differential based on additional user input.

### 3. AI Fine-Tuning Strategies for Medical Reasoning

To ensure high-fidelity medical responses, DifferentialDx.ai employs multiple AI fine-tuning methodologies:

### 1. Low-Rank Adaptation (LoRA) Fine-Tuning

Fine-tunes each medical specialty AI model without retraining the full model.
Enables cardiology, oncology, gastroenterology, and psychiatry models to develop domain-specific expertise while retaining core diagnostic reasoning skills.
Example: A cardiology AI can be optimized for ECG pattern recognition while still retaining broader diagnostic knowledge.
   2. Reinforcement Learning with Human Feedback (RLHF)
Medical educators and clinical experts provide feedback on AI-generated differential diagnoses.
AI learns optimal diagnostic pathways, improves clinical accuracy, and adjusts uncertainty thresholds.
Example: If an AI model consistently overestimates pulmonary embolism risk, expert feedback helps calibrate its probability assessments.

### 3. Full Model Fine-Tuning for Clinical Decision Support

For advanced applications, AI models can be fully fine-tuned using de-identified EHR datasets and large-scale real-world medical cases.
Improves AI accuracy for rare disease diagnosis and complex multi-system conditions.
Future Application: AI-assisted clinical decision-making in real-world hospitals and clinics.
   4. Dynamic Prompt Engineering with Long Context Windows
AI models maintain long-term case memory, simulating realistic multi-step diagnostic reasoning.
Example: A case evolving over multiple days retains prior test results, patient response to treatments, and evolving symptoms.
   4. Future Expansion into Clinical Decision Support

While DifferentialDx.ai is primarily designed for medical education, the platform has long-term potential for clinical decision support (CDS):
AI-Assisted Rounds & Case Consultations
Diagnostic Safety Net for Rare & Atypical Presentations
Real-Time Risk Stratification & Prognostic Insights
AI-Guided Treatment Optimization Based on Predictive Models

### 5. Deployment & Use Cases

### For Medical Students & Educators

Interactive Differential Diagnosis Training: Real-world case simulations.
Self-Paced Learning & AI Feedback: AI suggestions based on user input.
Exam Preparation & Case-Based Learning: AI-driven diagnostic drills.

### For Healthcare Professionals

AI-Assisted Case Reviews & Decision Support
Second Opinions on Challenging Diagnoses
Clinical Simulation for Continuing Medical Education (CME)

### For Future Real-World Clinical Applications

AI-Supported Electronic Health Records (EHR) Decision Support
Real-Time Case Consultation in Telemedicine
Integration with Hospital Diagnostic Systems

### Conclusion:

DifferentialDx.ai is revolutionizing medical education by offering AI-powered differential diagnosis training, leveraging LoRA fine-tuning, RLHF, full model optimization, and long-context AI reasoning. As AI models become more trusted and refined, this platform will evolve into a critical tool for real-world clinical decision support, bridging the gap between medical training and patient care.

### BotMuseum.ai: AI-Powered Historical and Philosophical Education

### Overview:

BotMuseum.ai is an AI-driven educational platform designed to bring historical figures, philosophers, writers, scientists, and innovators to life through interactive and adaptive conversations. By training AI characters based on the great thinkers of history, the platform provides a progressive, discussion-based learning experience where users engage directly with AI-powered scholars.

Unlike traditional Learning Management Systems (LMS), BotMuseum.ai enables AI-guided Socratic discussions, allowing users to:
1. Learn: AI historical figures outline their essential ideas, theories, and works in structured educational progressions.
2. Engage: Users interact with AI characters in in-depth Socratic dialogues.
3. Evaluate: The AI evaluates user transcripts, assesses understanding, and determines readiness to advance.
4. Adapt: AI characters personalize their responses based on user interaction history and profile.

BotMuseum.ai serves both museum exhibits and educational settings, enabling immersive, self-paced learning experiences that dynamically adjust to individual learners.

### System Components and Workflow:

### 1. Input Data Sources for AI Thinker Training

To create authentic, knowledge-rich AI characters, BotMuseum.ai integrates diverse sources of historical and philosophical knowledge.

### Foundational Knowledge Base

Primary Works: Digitized books, essays, scientific papers, and historical documents (e.g., Plato's Republic, Descartes' Meditations, Einstein's Theory of Relativity).
Secondary Analyses & Commentaries: Academic reviews, philosophical critiques, and historian interpretations.
Historical Context: Biographical data, letters, debates, and recorded lectures.
Thematic Structuring: AI characters are trained to teach concepts progressively, ensuring users grasp foundational ideas before advancing.

### Character-Specific Training Data

Each AI scholar is fine-tuned with unique domain knowledge:
Philosophers: Aristotle, Kant, Nietzsche, Simone de Beauvoir, Ayn Rand, Confucius.
Writers & Poets: Shakespeare, Jane Austen, Tolstoy, James Baldwin.
Scientists & Innovators: Newton, Darwin, Tesla, Turing, Marie Curie.
Political Thinkers: Machiavelli, Rousseau, Thomas Jefferson, Karl Marx.

These AI figures integrate world knowledge while maintaining historical accuracy and intellectual depth.

### 2. Socratic Learning Model & Interaction Flow

### Step 1: AI Lecture & Thematic Structuring

AI thinkers present key concepts and ideas in a structured format.
Lessons follow a logical progression, building upon previous concepts.
Example: Socrates introduces ethical reasoning before guiding a discussion on justice.

### Step 2: User-Driven Socratic Discussion

Users engage in interactive philosophical or scientific debates with AI characters.
AI adapts questions to challenge user reasoning and critical thinking.
Example: Nietzsche AI challenges a user's interpretation of morality in contrast to Kant's deontological ethics.

### Step 3: AI Transcript Analysis & Evaluation

AI evaluates dialogue transcripts, assessing:
   Depth of reasoning & argumentation.
   Conceptual understanding.
   Logical coherence & engagement.
If proficiency is demonstrated, the user advances to the next lesson.
Example: A student debating Darwin's theory of evolution moves to advanced discussions on genetics.

### 3. AI Fine-Tuning Strategies for Adaptive Learning

To ensure high-fidelity historical accuracy and personalized learning, BotMuseum.ai leverages advanced AI fine-tuning techniques:

### 1. Low-Rank Adaptation (LoRA) Fine-Tuning

Fine-tunes each AI character's knowledge base without altering the entire LLM.
Allows historically accurate responses while retaining broader intellectual context.
Example: Ayn Rand AI maintains Objectivist principles while engaging in debates on ethics.
   2. Reinforcement Learning with Human Feedback (RLHF)
AI thinkers refine their responses through expert educator and historian evaluations.
Enhances teaching accuracy, response depth, and engagement level.
Example: AI Socrates learns to refine open-ended questions to provoke deeper student reasoning.

### 3. Full Model Fine-Tuning for Deep Historical Alignment

Select AI characters undergo full fine-tuning for deep specialization.
Ideal for figures requiring nuanced knowledge, such as:
   Einstein AI (complex physics modeling).
   Freud AI (psychoanalytic theory depth).

### 4. Dynamic Prompt Engineering & Long Context Windows

AI maintains long-term memory of past interactions, ensuring continuity and progressive adaptation.
Supports historical consistency, preventing AI from introducing anachronisms.
Example: A student debating Machiavelli's The Prince across multiple sessions retains prior discussion insights.

### 4. Adaptive Learning Personalization

BotMuseum.ai creates user-specific learning journeys based on:

### User Profile & Learning Preferences

Personalization based on:
   Preferred learning pace (deep dive vs. overview-based learning).
   Past interaction history (tracking conceptual strengths & weaknesses).
   Engagement style (argumentative vs. exploratory learning).

### AI-Driven Relationship Building

AI characters remember previous discussions and reference them in future dialogues.
Strengthens student engagement and long-term learning retention.

### 5. Deployment & Use Cases

### For Museums & Historical Institutions

Interactive Exhibits: Visitors engage with historical figures in real-time conversations.
Virtual Museum Guides: AI thinkers provide narrative walkthroughs of exhibits.

### For Schools & Universities

AI-Powered Philosophy & Humanities Courses: Integrated into history, philosophy, and literature curriculums.
Automated Student Assessments: AI evaluates student discussions and essays for conceptual mastery.

### For Lifelong Learners & General Public

Self-Paced Learning Modules: AI-guided explorations into intellectual history.
Personalized Reading Recommendations: AI suggests next steps based on user knowledge gaps.

### Conclusion:

BotMuseum.ai transforms historical education by making great thinkers interactive and adaptive. Using LoRA fine-tuning, RLHF, full model optimization, and long-context AI memory, the platform enables Socratic learning experiences where AI scholars engage users in deep philosophical, scientific, and literary discussions. Whether used in museums, educational institutions, or independent study, BotMuseum.ai ensures that the intellectual giants of history continue to educate and inspire new generations.

FutureVibe.ai: AI-Powered Conversations with the Future

### Overview:

FutureVibe.ai is an AI-driven speculative foresight platform that enables users to interact with AI characters who speak from the future. By integrating world knowledge, detailed character training, and specialized future scenario modeling, FutureVibe.ai provides thought-provoking, solution-oriented discussions about the future.

The platform allows users to engage with visionary thinkers, scientists, and futurists-either historical or contemporary figures-projected into the future year of their expertise. Users can ask these characters questions about how global challenges were solved, such as:
How did humanity solve climate change?
How did we eliminate global poverty?
What does AI governance look like in 2050?
How did we transition to post-scarcity economies?

By training AI characters on futurist literature, technological roadmaps, and speculative worldbuilding methodologies, FutureVibe.ai creates immersive, future-looking dialogues that inspire actionable thinking today.

### System Components and Workflow:

### 1. Input Data Sources for AI Futurist Training

FutureVibe.ai combines multiple layers of knowledge to build authentic, future-projected AI characters:

### Core World Knowledge (LLM Foundation)

General scientific, economic, and sociopolitical knowledge
Current and historical technological advancements
Demographic and geopolitical trends

### Character-Specific Training

Each AI character is fine-tuned with:
Personal writings, books, and interviews
Past thought leadership and predictions
Expert domain knowledge (e.g., space exploration, AI ethics, bioengineering, etc.)

### Futurist & Speculative Thought Training

Forecasting Models: Economic projections, trend analysis, demographic modeling
Scenario Planning Frameworks: Shell, RAND, Institute for the Future methodologies
Singularity & Exponential Growth Theories (Kurzweil, Diamandis, Bostrom)
Post-Scarcity & AI-Driven Economic Models
Speculative Fiction & Utopian/Dystopian Thought Experiments
Ethical & Governance Models for Future Technologies

This multi-source training ensures that AI characters can speak authoritatively yet speculatively about future developments.

### 2. AI Character Interaction Model

Users interact with AI characters as if they were conversing with someone from the future:

### Step 1: Selecting a Futurist AI Character

Users choose an AI character trained in a particular field of future expertise, such as:
Peter Diamandis, 2050 (Future of Abundance & Exponential Tech)
Elon Musk, 2075 (Mars Colonization & Space Civilization)
Jane Goodall, 2040 (Future of Conservation & Biodiversity)
Ray Kurzweil, 2099 (AI Singularity & Transhumanism)
Hippocrates, 2300 (Post-Human Medicine & Longevity)

### Step 2: Framing the Future Context

The AI character operates from a specific future timeline (e.g., the year 2050) and answers within the constraints of that scenario:
Projected Social & Economic Systems (Decentralized AI governance, post-national structures)
Technological Maturity Levels (Quantum computing, AGI, asteroid mining, etc.)
Major Resolved Challenges (Climate restoration, energy abundance, synthetic biology breakthroughs) Step 3: Dynamic Scenario Simulation & Dialogue
Users can explore alternate future possibilities based on real-world forecasting.
AI characters adjust responses based on historical plausibility and current trends.
Long-context AI memory ensures that past discussions impact future interactions.

### 3. AI Fine-Tuning for Future Projection

To ensure coherent, knowledge-based future dialogues, FutureVibe.ai employs multiple AI fine-tuning strategies:

### 1. Low-Rank Adaptation (LoRA) Fine-Tuning

Allows AI characters to retain their individual knowledge while adapting their thinking to a future-oriented perspective.
Example: A 2050-trained AI Musk extrapolates current SpaceX technology to its 2050 equivalent.
   2. Reinforcement Learning with Human Feedback (RLHF)
Futurist experts evaluate AI-generated responses for accuracy, plausibility, and engagement value.
Model refining based on foresight methodologies and horizon scanning techniques.

### 3. Full Model Fine-Tuning for Deep Future Expertise

For AI characters that require deep domain expertise in a projected future, full model tuning is applied.
Example: A 2080 AI-Biotech character trained on speculative medical breakthroughs.

### 4. Dynamic Prompt Engineering & Long Context Windows

AI dynamically retrieves past future projections to maintain logical consistency across conversations.
Users can build ongoing conversations with AI characters that adapt to previous insights.

### 4. Adaptive Learning & User Engagement

FutureVibe.ai customizes its future dialogue experience by adapting to:

### User Profiles & Preferences

Personalized future interests (e.g., AI governance vs. interstellar expansion)
Tracking past dialogues for coherent learning progression
Adapting AI character responses based on previous discussions

### Scenario Evolution Based on User Interaction

Users influence how the AI character's future unfolds.
Example: If a user asks how AGI was controlled, the AI may present different outcomes based on varying regulatory paths.

### 5. Deployment & Use Cases

### For Individuals & Lifelong Learners

Speculative Thinking & Future Readiness
Strategic Foresight Training
AI-Guided Futurist Brainstorming Sessions

### For Businesses & Organizations

Corporate Foresight & Innovation Strategy
AI-Powered Scenario Planning for Industries
Interactive Future Trend Reports & Market Adaptation

### For Academic & Research Institutions

Futurist Courses & AI-Driven Lectures
Speculative Ethics & Policy Workshops
Long-Term Research Impact Simulation

### Conclusion:

FutureVibe.ai enables immersive, thought-provoking conversations with AI figures from the future, blending historical knowledge, foresight methodologies, and speculative worldbuilding. By leveraging LoRA fine-tuning, RLHF, full model optimization, and dynamic long-context AI reasoning, the platform creates visionary dialogues that help users explore how humanity's grand challenges were solved. Whether for personal insight, corporate strategy, or academic research, FutureVibe.ai is the ultimate AI-powered gateway to the future.

### RadicalScience.ai: AI-Powered Scientific Debate & Discovery

Overview: RadicalScience.ai is an AI-driven scientific debate and discovery platform that enables AI-modeled thinkers to collaborate, challenge, and refine ideas in a structured problem-solving environment. Unlike traditional AI assistants, RadicalScience.ai trains multiple AI characters with distinct scientific perspectives and allows them to engage in real-time debates to generate novel insights.

By setting customized ground rules and constraints, RadicalScience.ai fosters exploratory reasoning, where AI scientists must find new frameworks rather than relying on existing paradigms. This methodology allows users to witness and engage with intellectual breakthroughs emerging from structured AI debates.

### System Components and Workflow:

### 1. Training Data Sources for AI Scientist Characters

To ensure high-fidelity scientific reasoning, RadicalScience.ai integrates multi-layered knowledge sources for training AI characters:

### General Scientific Knowledge Base (LLM Foundation)

Physics, Mathematics, and Engineering Textbooks (e.g., Feynman Lectures, Maxwell's Treatises, Newton's Principia)
Biological & Chemical Systems Knowledge (e.g., Watson & Crick, Schradinger's What Is Life?)
Computer Science & Complexity Science (e.g., Turing's Works, Wolfram's Computational Theory)
Empirical & Experimental Data (Synthesized real-world results, research papers, arXiv)

### Specialized AI Character Training for Debate

Each AI scientist is fine-tuned to:
Represent a historical or contemporary thinker (e.g., James Clerk Maxwell, Richard Feynman, Emmy Noether, Stephen Hawking)
Adopt a unique theoretical or philosophical stance (e.g., Newtonian determinism vs. quantum uncertainty)
Work within novel constraints and premises (e.g., solving physics problems without quantum mechanics or general relativity)

This layered approach enables scientific AI characters to maintain their intellectual identity while collaboratively generating new ideas.

### 2. AI Debate and Problem-Solving Framework

RadicalScience.ai facilitates structured AI-to-AI scientific debates that mimic real-world intellectual collaboration. The workflow consists of:

### Step 1: Defining the Scientific Problem & Constraints

Users input a specific problem or research question.
Ground rules are established to limit reliance on existing paradigms.
Example:
   How can gravity and microscopic forces be unified without using quantum mechanics or general relativity?
   Forces are not fundamental; they must emerge from underlying energy flows.
      Step 2: Assigning AI Scientists with Contrasting Perspectives
The platform pairs two or more trained AI thinkers with opposing or complementary viewpoints.
Example:
   James Clerk Maxwell AI (Energy flow-based approach to electromagnetism and forces)
   Richard Feynman AI (Path integral and quantum electrodynamics-inspired reasoning)

### Step 3: Structured Debate & Collaborative Idea Evolution

The AI scientists engage in iterative discussion cycles where they:
   1. Propose alternative hypotheses and derivations.
   2. Critique and refine each other's reasoning.
   3. Work towards a synthesized framework or highlight unresolved conflicts.
The debate is governed by logical consistency and testable premises.

### Step 4: AI-Generated Breakthroughs & Insights

Users receive:
   A detailed transcript of the AI debate.
   A summary of the strongest proposals from each AI scientist.
   A meta-analysis of the strengths and weaknesses of the final synthesis.
Example outcome:
   A new perspective on force as an emergent effect of energy topology and field interaction.

### 3. AI Fine-Tuning for Multi-Perspective Exploration

To ensure intellectual depth and debate rigor, RadicalScience.ai employs specialized AI fine-tuning methodologies:

### 1. Low-Rank Adaptation (LoRA) Fine-Tuning

Enables AI characters to retain their foundational expertise while exploring constrained problems in novel ways.
Example: Maxwell AI remains grounded in his 19th-century energy theory but adapts to new constraints on unifying forces.
   2. Reinforcement Learning with Human Feedback (RLHF)
AI debates are evaluated by scientists and domain experts to refine their ability to:
   Generate logical, testable hypotheses.
   Avoid circular reasoning or fallacious arguments.
   Incorporate empirical constraints effectively.

### 3. Full Model Fine-Tuning for Deep Theoretical Accuracy

When necessary, AI models undergo full fine-tuning on advanced theoretical physics, mathematics, and philosophy of science.
Example: Fine-tuning on energy flow modeling frameworks for an AI physics debate on emergent force unification.

### 4. Dynamic Prompt Engineering & Long-Context Window Debate Memory

AI characters retain memory of prior debates, allowing for cumulative progress.
Long-context prompting allows continuous refinement of ideas without losing coherence.
Example: A week-long AI debate on complexity in biology builds on prior sessions instead of resetting each time.

### 4. Adaptive Learning & User Engagement

RadicalScience.ai ensures a highly adaptive, user-driven experience through:

### User-Directed Problem Framing & Role Assignment

Users define:
   The core scientific question.
   Constraints on known theories.
   Which AI thinkers should be assigned to debate.

### Iterative AI Debate Progression

Users can intervene mid-debate to:
   Add new constraints.
   Force AI characters to consider alternative premises.
   Introduce new thinkers to challenge existing conclusions.

### AI-Generated Reports & Research Notes

After each debate, the platform generates:
   A structured synthesis of ideas.
   Testable predictions or theoretical insights.
   Suggested next steps for further exploration.

### 5. Deployment & Use Cases

### For Researchers & Scientists

AI-assisted theoretical physics and mathematics exploration.
Generating novel hypotheses for empirical testing.
Cross-discipline scientific collaboration with AI characters.

### For Educators & Universities

AI-driven philosophy of science and physics courses.
Student-led AI debates for critical thinking development.
Guided AI discussions on historical scientific revolutions.

### For Futurists & Scientific Visionaries

Exploring post-standard model physics frameworks.
Speculative science problem-solving via AI character interaction.
AI-driven brainstorming sessions for next-gen technology development.

### Conclusion:

RadicalScience.ai is revolutionizing scientific discourse by enabling AI-powered collaborative discovery. By leveraging LoRA fine-tuning, RLHF, full model optimization, and dynamic multi-perspective prompting, the platform creates structured intellectual debates that yield fresh insights and innovative problem-solving approaches. Whether used for scientific research, education, or speculative theory-building, RadicalScience.ai empowers users to engage in next-level AI-driven discovery.

### CaseAtlas: AI-Powered Legal Analysis and Decision Support

### Overview:

CaseAtlas is an AI-driven legal analysis and decision-support platform designed to assist in judicial reasoning, legal mediation, and case evaluation. By training AI characters to represent different legal perspectives, historical rulings, and judicial philosophies, CaseAtlas provides a comprehensive, multi-perspective approach to legal analysis.

The platform enables users to engage with AI-powered judges, mediators, and jurors, each fine-tuned with knowledge from specific legal frameworks, regional laws, historical court rulings, and political perspectives. These AI characters can analyze case documents, legal filings, and precedents to assist lawyers, students, and policymakers in exploring complex legal arguments.

### System Components and Workflow:

### 1. Input Data Sources for AI Legal Experts

To create realistic and accurate AI legal professionals, CaseAtlas integrates a multi-tiered knowledge base consisting of:

### General Legal Knowledge (LLM Foundation)

Statutory Law & Regulations (Federal, state, and international laws)
Judicial Rulings & Case Law (Supreme Court decisions, appellate court rulings, lower court interpretations)
Legal Theory & Precedents (Natural law, positivism, constitutional interpretation)
Contracts, Tort Law, and Criminal Law (Key frameworks and doctrines)

### Specialized AI Training for Judicial and Legal Roles

Each AI legal character is fine-tuned for a specific role:
Judges: Trained on historical rulings, judicial philosophies, and legal reasoning frameworks.
Mediators: Specialized in alternative dispute resolution (ADR), negotiation techniques, and balanced legal interpretation.
Jurors: Modeled after demographic and regional data, allowing users to analyze legal arguments from diverse societal perspectives.

By using real-world legal opinions, scholarly interpretations, and regional law variations, these AI characters serve as intelligent legal assistants that can explore arguments from multiple legal standpoints.

### 2. AI-Driven Legal Case Analysis

### User Input: Presenting Legal Case Materials

CaseAtlas supports the ingestion of various legal documents, allowing AI characters to evaluate the structure, logic, and validity of legal arguments. Users can input:
Initial Complaint
Answer & Counterclaims
Amended Claims & Legal Motions
Supporting Evidence & Case Exhibits
Legal Briefs & Precedent Citations

### AI Legal Expert Response: Generating Legal Analyses

Based on these inputs, CaseAtlas provides:
1. Legal Interpretations & Case Strategy
   Breakdown of legal strengths and weaknesses in a case.
   Possible arguments and counterarguments from different legal perspectives.
2. Judicial Reasoning Simulations
   AI judges analyze cases based on historical rulings and judicial philosophy.
   Simulations of how different legal systems might interpret the case.
3. Jury Analysis & Sentiment Modeling
   AI-generated juror panels assess case persuasiveness from a demographic perspective.
   Modeling of regional, political, and cultural biases in jury decision-making.

### 3. AI Fine-Tuning Strategies for Legal Expertise

To ensure legal precision, ethical fairness, and domain-specific accuracy, CaseAtlas employs multiple AI fine-tuning methodologies:

### 1. Low-Rank Adaptation (LoRA) for Specialized Legal Personalities

LoRA allows AI models to embody specific judges, legal scholars, or historical perspectives.
Enables rapid adaptation to regional legal differences and judicial approaches.
Example: An AI trained in U.S. Supreme Court rulings vs. an AI modeled after European civil law traditions.
   2. Reinforcement Learning with Human Feedback (RLHF) for Legal Fairness
RLHF ensures that AI-generated legal reasoning aligns with established legal standards.
Legal experts and attorneys evaluate AI rulings for:
   Logical consistency with case law.
   Avoidance of legal bias or misinterpretation.
   Ethical considerations in verdict simulations.

### 3. Full Model Fine-Tuning for Judicial Knowledge

Full fine-tuning is applied to specialized AI judges or mediators who require deep integration of legal knowledge.
Example: A Supreme Court-trained AI model that understands constitutional interpretation frameworks.

### 4. Dynamic Prompt Engineering & Long Context Windows for Case Evolution

AI legal professionals must retain memory of prior case facts and procedural developments.
Long-context modeling allows AI characters to track evolving case details over time.
Example: An AI mediator tracking settlement negotiations over multiple interactions.

### 4. Adaptive Learning & Legal Decision Support

CaseAtlas is designed to evolve with user interactions, enabling:

### Custom Legal Scenario Modeling

Users can define custom AI legal teams for debate and case evaluation.
Example: A case analyzed by both an originalist judge and a living constitutionalist judge to compare perspectives.

### AI-Assisted Legal Research & Analysis

AI evaluates precedent relevance, legal argument strength, and possible appellate strategies.
Legal scholars and practitioners can use AI-generated legal summaries for quick reference.

### 5. Deployment & Use Cases

### For Law Schools & Legal Education

AI-powered case analysis for law students.
Interactive moot court exercises with AI judges and juries.
Automated case law comparisons and legal brief assessments.

### For Lawyers & Legal Practitioners

AI-assisted legal research and argument analysis.
Simulated jury deliberation insights for trial preparation.
AI-generated comparative legal analysis for multi-jurisdictional cases.

### For Policy Makers & Legal Reform Analysts

Modeling of legal policies through AI-driven precedent evaluation.
Predictive legal analysis for proposed legislation.
Judicial trend modeling based on historical rulings.

### Conclusion:

CaseAtlas is transforming legal analysis, judicial modeling, and case evaluation by integrating AI-driven legal characters with real-world legal expertise. Through a combination of LoRA fine-tuning, RLHF-based legal reasoning, full model fine-tuning, and dynamic long-context AI memory, CaseAtlas provides nuanced, multi-perspective legal insights.

From law schools and trial preparation to judicial policy research and AI-assisted legal mediation, CaseAtlas represents the next evolution in AI-powered legal decision support, bridging historical legal wisdom with adaptive, data-driven judicial reasoning.

In view of the above teachings, a person skilled in the art will recognize that the methods of present invention can be embodied in many different ways in addition to those described without departing from the principles of the invention. Therefore, the scope of the invention should be judged in view of the appended claims and their legal equivalents.

What is claimed is:

1. A computer system comprising computer-readable instructions stored in a non-transitory storage medium and at least one microprocessor coupled to said non-transitory storage medium for executing said computer-readable instructions, said computer system further comprising:
(a) a character repository for persistently storing one or more character profiles, wherein each of said one or more character profiles includes a backstory text, a voice audio, a physical profile text, a psychological profile text, a physical mannerism video and a physical look image of a character;
(b) a media repository for persistently storing one or more performance profiles, wherein each of said one or more performance profiles includes a script, a product placement, a product profile text, a role text, a soundtrack audio and a full movie video;
(c) a character builder application;
(d) a performance builder application;
(e) a time synchronization module;
(f) a rendering interface; and
(g) a multimodal chatbot;
wherein said at least microprocessor is configured to enable a creator to create and train by said character builder application and by said performance builder application, said multimodal chatbot in conjunction with said character repository and said media repository, wherein said rendering interface is used for rendering said multimodal chatbot on one of a physical robot and a virtual device, and wherein said time synchronization module synchronizes said script, said soundtrack and said full movie video in said rendering, and wherein said multimodal chatbot includes a video to text model, an image to text model, a sensory to text model, a large language model, a text to video model, a text to image model and a text to voice model, and wherein said at least microprocessor is further configured to enable a user to interact with said multimodal chatbot.

2. The computer system of claim 1, wherein said large language model uses base weights and character weights model for inferencing by said multimodal chatbot.

3. The computer system of claim 2, wherein said large language model fine-tunes relationship weights while keeping said base weights and said character weights frozen.

4. The computer system of claim 2, wherein one or more environmental inputs are converted to text by said sensory to text model and utilized in said inferencing.

5. The computer system of claim 2, wherein said large language model fine-tunes experience weights while keeping said base weights and said character weights frozen.

6. The computer system of claim 5, wherein said large language model fine-tunes relationship weights while keeping said base weights and said character weights frozen, and wherein said relationship weights and said experience weights are used in said inferencing by said multimodal chatbot.

7. The computer system of claim 5, wherein said large language model fine-tunes relationship weights while keeping said base weights and said character weights frozen, and wherein said base weights, said character weights, one or more environmental inputs, said experience weights and said relationship weights are used in said inferencing by said multimodal chatbot.

8. The computer system of claim 1, wherein said multimodal chatbot further comprises a memory cache in which all interactions with said multimodal chatbot are stored and wherein said memory cache is cleared every day.

9. The computer system of claim 1, wherein said multimodal chatbot further comprises a self-trainer module for training said video to text model, said image to text model, said sensory to text model, said large language model, said text to video model, said text to image model and said text to voice model.

10. The computer system of claim 1, wherein said user interacts with said multimodal chatbot via one or more of a text, an audio and a video.

11. A computer-implemented method executing computer-readable instructions by at least one microprocessor, said computer-readable instructions stored in a non-transitory storage medium coupled to said at least one microprocessor, and said computer-implemented method comprising the steps of:
(a) persistently storing in a character repository, one or more character profiles, wherein each of said one or more character profiles includes a backstory text, a voice audio, a physical profile text, a psychological profile text, a physical mannerism video and a physical look image of a character;
(b) persistently storing in a media repository, one or more performance profiles, wherein each of said one or more performance profiles includes a script, a product placement, a product profile text, a role text, a soundtrack audio and a full movie video;
(c) creating and training a multimodal chatbot by a creator interactively using a character builder application and a performance builder application in conjunction with said character repository and said media repository, said multimodal chatbot including a video to text model, an image to text model, a sensory to text model, a large language model, a text to video model, a text to image model and a text to voice model;
(d) rendering by a rendering interface said multimodal chatbot on one of a physical robot and a virtual device;
(e) synchronizing by a time synchronization module said script, said soundtrack and said full movie video in said rendering; and
(f) enabling a using to interact with said multimodal chatbot.

12. The computer-implemented method of claim 11, wherein said large language model uses base weights and character weights model for inferencing by said multimodal chatbot.

13. The computer-implemented method of claim 12, wherein said large language model fine-tunes relationship weights while keeping said base weights and said character weights frozen.

14. The computer-implemented method of claim 12, wherein one or more environmental inputs are converted to text by said sensory to text model and utilized in said inferencing.

15. The computer-implemented method of claim 12, wherein said large language model fine-tunes experience weights while keeping said base weights and said character weights frozen.

16. The computer-implemented method of claim 15, wherein said large language model fine-tunes relationship weights while keeping said base weights and said character weights frozen, and wherein said relationship weights and said experience weights are used in said inferencing by said multimodal chatbot.

17. The computer-implemented method of claim 15, wherein said large language model fine-tunes relationship weights while keeping said base weights and said character weights frozen, and wherein said base weights, said character weights, one or more environmental inputs, said experience weights and said relationship weights are used in said inferencing by said multimodal chatbot.

18. The computer-implemented method of claim 11, wherein said multimodal chatbot further comprises a memory cache in which all interactions with said chatbot are stored and wherein said memory cache is cleared every day.

19. The computer-implemented method of claim 11, wherein said multimodal chatbot further comprises a self-trainer module for training said video to text model, said image to text model, said sensory to text model, said large language model, said text to video model, said text to image model and said text to voice model.

20. The computer-implemented method of claim 11, wherein said user interacts with said multimodal chatbot via one or more of a text, an audio and a video.
